(19) United States
(12) Patent Application Publication
(10) Pub. No.: US 2013/0090909 A1
(43) Pub. Date: Apr. 11, 2013

(54) Method And System For Functional Evolutionary Assessment Of Genetic Variants

(71) Applicants: Joel T. Dudley, Rye, NY (US); Atul J. Butte, Menlo Park, CA (US)

(72) Inventors: Joel T. Dudley, Rye, NY (US); Atul J. Butte, Menlo Park, CA (US)

(73) Assignee: The Board of Trustees of the Leland Stanford Junior University, Palo Alto, CA (US)

(21) Appl. No.: 13/536,107

(22) Filed: Jun. 28, 2012

Related U.S. Application Data
(60) Provisional application No. 61/502,175, filed on Jun. 28, 2011.

(51) Int. Cl. G06F 19/12

(52) U.S. Cl. CPC G06F 19/12
USPC 703/11

(57) ABSTRACT

Embodiments of the present invention provide methods and systems that perform comprehensive assessment of genetic variation presenting in a personal genome and provide quantitative diagnosis of the impact of each variant on physiological function and patient health.

### CROSS-REFERENCE TO RELATED APPLICATIONS

This application claims priority to U.S. Provisional Application No. 61/502,175 filed Jun. 28, 2011, which is hereby incorporated by reference in its entirety for all purposes.

### STATEMENT OF GOVERNMENT SPONSORED SUPPORT

This invention was made with Government support under contract LM007033 awarded by the National Institutes of Health. The Government has certain rights in this invention.

### FIELD OF THE INVENTION

The present invention generally relates to the field of genomics. More particularly, the present invention relates to the field of whole genome sequencing.

### BACKGROUND OF THE INVENTION

One of the challenges in genomic medicine is to translate fundamental scientific discoveries regarding the structure, variation, and function of the genomes of individuals and populations towards improved health outcomes. Current National Human Genome Research Institute (NHGRI) director Dr. Eric Green refers to this challenge as the “base pairs to bedside” vision for genomic medicine (Green, E. D., Guyer, M. S. & National Human Genome Research, I. Charting a course for genomic medicine from base pairs to bedside. Nature 470, 204-213 (2011); these and all other references cited herein are incorporated by reference for all purposes). From a fundamental understanding of the biology of genomes, hypotheses concerning the genomic bases of disease etiology and pathophysiology, whose findings can be brought to bear in hypothesis-driven clinical studies towards evidence-based improvements in the effectiveness of healthcare, can be understood and evaluated. Although successful efforts demonstrating genomics-based discoveries and innovations in clinical care are emerging, the current incomplete understanding of genome biology and its role in human disease presently limits the scope and breadth of scientific and clinical efforts that can be undertaken towards driving genomics-based improvements in healthcare.

Due to recent advances in molecular profiling technologies, it is now possible to quickly and reliably measure genome-wide patterns of structure, variation, and expression; however, it remains difficult to establish functional expectations for genomic elements due to the paucity of such data measured from large samples of healthy and diseaseaffected populations. Because biomolecular and gross physiological phenotypes are products of genetic components and their interactions with themselves (e.g., epistasis) and environmental factors across multiple scales, complete knowledge of genome function requires consideration of all such possible interactions. Under a basic model, the single nucleotide position (e.g., base pair) can be considered as the most basic functional genomic unit, and indeed it is well established that single nucleotide polymorphisms (SNPs), which represent the most common form of genomic variation in humans, can have a profound impact on development and function. Given that there are approximately three billion such single nucleotide base pair units in an average human genome capable of rendering direct and indirect functional effects through structural properties, direct expression, or interactions with endogenous or exogenous macromolecules, full assessment of the vast combinatorial space of the functional dynamic range of just SNPs alone is presently intractable.

Fortunately each position in the human genome has undergone functional assessment over the course of species evolution spanning millions to billions of years, and the results of this great experiment are latent in the collective genomes of humankind's close and distant animal relatives. Although the evolutionary history of a position cannot generally be used to directly infer the precise biochemical or structural characteristics of a genomic position—though short, conserved sequence motifs can sometimes be prescriptive in this regard—they contain rich information that can be used to establish baseline expectations. The most classic example of this is patterns of amino acid sequence conservation, which enables the establishment of quantitative prior expectations on which amino acids bases are likely to be observed at various positions in the human proteome (Grantham, R. Amino acid difference formula to help explain protein evolution. Science 185, 862-864 (1974)). Residue conservation represents just one among many features that can be inferred from evolutionary histories. Despite many examples of successful applications of evolutionary priors in biological science, comparatively few examples of using evolutionary priors for biomedical discovery or genomic medicine have been described.

### SUMMARY OF THE INVENTION

The overarching issue within the present disclosure is to explore and lay the groundwork for Evolutionary Genomic Medicine, which is the intersection of medicine, genomes, and evolutionary biology where data and methods from all three disciplines can be unified under coherent theoretical or methodological models using bioinformatics approaches towards the evaluation of translational hypotheses having direct implications for health. Under this model, evolutionary theory, data, and methods are used to establish expectations for genome biology, which in turn enable more robust evaluations of genome biology and its roles in disease etiology, pathophysiology, or response to treatment.

In an embodiment of the invention a method and system are provided that perform comprehensive assessment of genetic variation presenting in a personal genome and provide quantitative diagnosis of the impact of each variant on physiological function and patient health.

Among other things, the present invention provides a system of methods for functional evolutionary assessment of genetic variants presenting in a personal genome and their implementation. The system is formed by a group of methods that estimate evolutionary prior parameters for each nucleotide in the human reference genome aligned to the genomes of other mammalian species having full genome sequence information. For each nucleotide in the human reference genome, these methods estimate an evolutionary rate of change, a positional conservation metric, and an evolutionary-permissible allele profile. These features can be used alone or in combination to establish prior expectations that an allele at a position will have clinical relevance.

These and other embodiments can be more fully appreciated upon an understanding of the detailed description of the invention as disclosed below in conjunction with the attached figures.

### BRIEF DESCRIPTION OF THE DRAWINGS

The following drawings will be used to more fully describe embodiments of the present invention.

FIG. 1 is a diagram that presents an overview of a problem domain according to embodiments of the present invention.

FIG. 2a-b are schematic diagrams showing the macroevolutionary (long-term) and microevolutionary (short-term; within population) context of personal genomes.

FIG. 3 is a chart of the distribution of evolutionary rates of positions harboring Mendelian diseaseassociated mutations and population polymorphisms according to an embodiment of the present invention.

FIG. 4 is a chart of evolutionary rates of amino acid sites harboring personal variants in four completely sequenced human genomes according to an embodiment of the present invention.

FIG. 5 is a chart of the relationship between cross-species evolutionary rate and minor allele frequency in modern human populations according to an embodiment of the present invention.

FIG. 6 is a chart of the relative frequency of neutral to adaptive mutations that will reach high frequency (HF: 50%-90%) in a population according to an embodiment of the present invention.

FIG. 7 is a timetree of 36 mammalian species used for deriving evolutionary information for each SNP. Species divergence times were obtained from www.timetree.org (Hedges, S. B., Dudley, J. & Kumar, S. TimeTree: a public knowledge-base of divergence times among organisms. Bioinformatics 22, 2971-2972 (2006)) according to an embodiment of the present invention.

FIG. 8 is a chart of the relationship of the observed-to-expected numbers of disease-associated SNPs at different levels of evolutionary constraint according to an embodiment of the present invention.

FIG. 9 is a chart of a comparison of average conservation of coding (grey squares) and non-coding (circles) dSNPs and high-confidence (HC) dSNPs to HapMap3 SNPs according to an embodiment of the present invention.

FIG. 10 is a chart of the distribution of evolutionary conservation for GWAS dSNPs according to an embodiment of the present invention.

FIG. 11 is a chart of the relationship between the odds ratio reported for disease associated variants and the evolutionary conservation of the genomic position harboring the variant according to an embodiment of the present invention.

FIG. 12 is a chart of the relationship between odds ratio and evolutionary rate according to an embodiment of the present invention.

FIG. 13 is a chart of the relationship of the multispecies evolutionary rate with the minor allele frequencies (MAF) in human populations according to an embodiment of the present invention.

FIG. 14 is a chart of the influence of evolutionary rate on the risk allele frequency disparities between cases and controls according to an embodiment of the present invention.

FIG. 15a-g are a charts demonstrating that evolutionary adjustment improves discriminatory power to identify reproducible associations according to an embodiment of the present invention.

FIG. 16 is a chart of the relationship between gain in accuracy from evolutionary adjustment and disease heritability according to an embodiment of the present invention.

FIG. 17 is a chart of the Receiver Operating Characteristic Curve for the low dose classification algorithms according to an embodiment of the present invention.

FIG. 18 is a chart of the Receiver Operating Characteristic Curve for the high dose classification algorithms according to an embodiment of the present invention.

FIG. 19 is a chart of the distributions of positional evolutionary conservation for pharmacogenomics and population SNPs according to an embodiment of the present invention.

FIG. 20 is a chart of the Receiver Operating Characteristic Curve for the high dose classification comparing the pHap and evo-pHap methods according to an embodiment of the present invention.

FIG. 21 is a chart of the Receiver Operating Characteristic Curve for the low dose classification comparing the pHap and evo-pHap methods according to an embodiment of the present invention.

FIG. 22 (Table 1) is a table of examples of genes harboring human disease mutations for which empirical molecular evidence supports a putative role for positive natural selection acting on emerged gene variants according to an embodiment of the present invention.

FIG. 23 (Table 2) is a summary table of disease-associated variants used in the study according to an embodiment of the present invention.

FIG. 24 (Table 3) is a table of the number of GWAS dSNP regions tagged by E-rank vs. P-rank according to an embodiment of the present invention.

FIG. 25 (Table 4) is a table of the top 10 of 3,856 SNPs fitting a univariate linear regression model of warfarin dose for 181 patients according to an embodiment of the present invention.

FIG. 26 (Table 5) is a table of genes with candidate gene-scores that significantly predict dose in a univariate linear regression model (p≦0.05) according to an embodiment of the present invention.

FIG. 27 (Table 6) is a table of the top 20 genes with candidate gene-scores that significantly distinguish between low dose patients and non-low-dose patients (p≦0.05) according to an embodiment of the present invention.

FIG. 28 (Table 7) is a table of the top 15 genes with candidate gene-scores that significantly distinguish between high dose patients and non-high-dose patients (p≦0.05) according to an embodiment of the present invention.

FIG. 29 (Table 8) is a table of gold standard disease SNPs according to an embodiment of the present invention.

FIG. 30 is a block diagram of a computer system on which the present invention can be implemented.

FIG. 31, is a block diagram of a method according to an embodiment of the present invention for functional evolutionary assessment of genetic variants presenting in a personal genome.

### DETAILED DESCRIPTION OF THE INVENTION

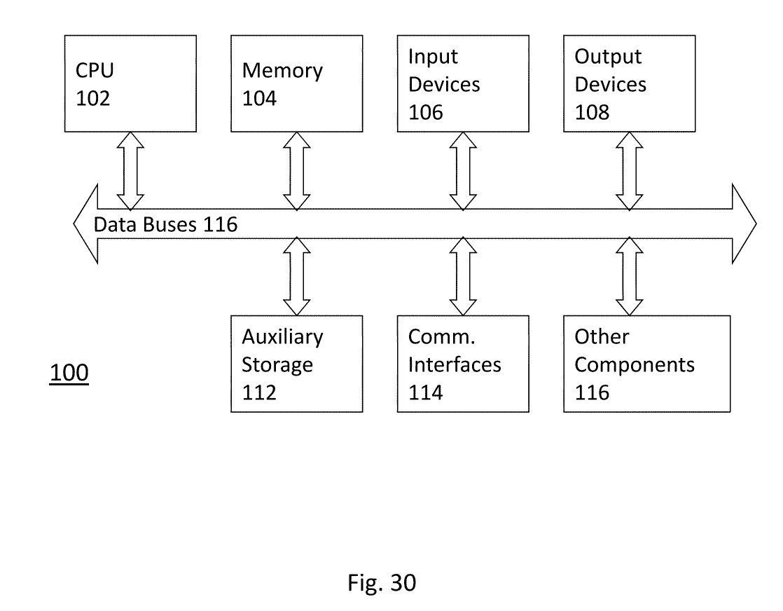

Among other things, the present invention relates to methods, techniques, and algorithms that are intended to be implemented in a digital computer system 100 such as generally shown in FIG. 30. Such a digital computer or embedded device is well-known in the art and may include the following.

Computer system 100 may include at least one central processing unit 102 but may include many processors or processing cores. Computer system 100 may further include memory 104 in different forms such as RAM, ROM, hard disk, optical drives, and removable drives that may further include drive controllers and other hardware. Auxiliary storage 112 may also be include that can be similar to memory 104 but may be more remotely incorporated such as in a distributed computer system with distributed memory capabilities.

Computer system 100 may further include at least one output device 108 such as a display unit, video hardware, or other peripherals (e.g., printer). At least one input device 106 may also be included in computer system 100 that may include a pointing device (e.g., mouse), a text input device (e.g., keyboard), or touch screen.

Communications interfaces 114 also form an important aspect of computer system 100 especially where computer system 100 is deployed as a distributed computer system. Computer interfaces 114 may include LAN network adapters, WAN network adapters, wireless interfaces, Bluetooth interfaces, modems and other networking interfaces as currently available and as may be developed in the future.

Computer system 100 may further include other components 116 that may be generally available components as well as specially developed components for implementation of the present invention. Importantly, computer system 100 incorporates various data buses 116 that are intended to allow for communication of the various components of computer system 100. Data buses 116 include, for example, input/output buses and bus controllers.

Indeed, the present invention is not limited to computer system 100 as known at the time of the invention. Instead, the present invention is intended to be deployed in future computer systems with more advanced technology that can make use of all aspects of the present invention. It is expected that computer technology will continue to advance but one of ordinary skill in the art will be able to take the present disclosure and implement the described teachings on the more advanced computers or other digital devices such as mobile telephones or “smart” televisions as they become available. Moreover, the present invention may be implemented on one or more distributed computers. Still further, the present invention may be implemented in various types of software languages including C, C++, and others. Also, one of ordinary skill in the art is familiar with compiling software source code into executable software that may be stored in various forms and in various media (e.g., magnetic, optical, solid state, etc.). One of ordinary skill in the art is familiar with the use of computers and software languages and, with an understanding of the present disclosure, will be able to implement the present teachings for use on a wide variety of computers.

The present disclosure provides a detailed explanation of the present invention with detailed explanations that allow one of ordinary skill in the art to implement the present invention into a computerized method. Certain of these and other details are not included in the present disclosure so as not to detract from the teachings presented herein but it is understood that one of ordinary skill in the at would be familiar with such details.

Embodiments of the present invention, from the perspective of medicine, include evolutionary prior information that is both quantitative and empirical, as opposed to evolutionary narratives that are traditionally associated with medical issues that do not offer a means to improve understanding, diagnosis, or treatment. This approach is advantageous from the perspective of evolutionary biology, because, by having a strong focus on health improvement, a new line of evolutionary hypotheses is established whose ultimate evaluation is rooted in clinical utility rather than establishment of general evolutionary theory.

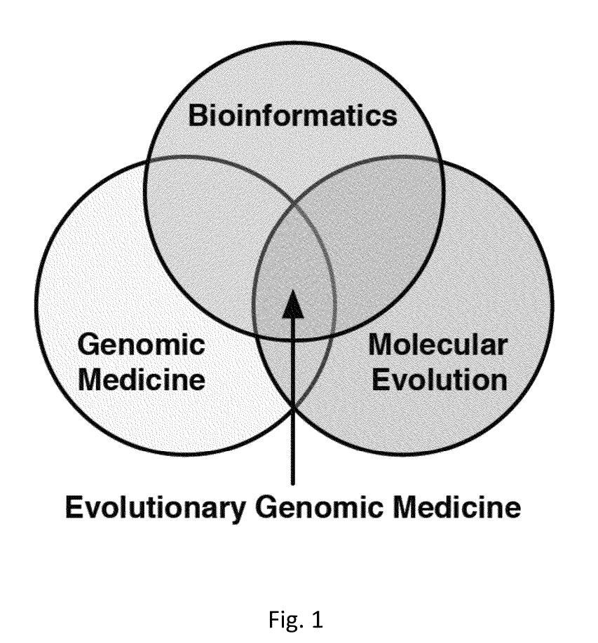

For example, shown in FIG. 1 is a diagram that presents an overview of the problem domain according to embodiments of the present invention. FIG. 1 illustrates that embodiments of the present invention lie at the intersection of the domains of bioinformatics, genomic medicine, and molecular evolution. Under this model, bioinformatics approaches are taken to incorporate molecular evolutionary theory and methods with clinically relevant genomic data to directly address important problems in medicine.

The evolutionary genomic medicine of human genetic variation has been investigated as it pertains to disease biology, etiology, diagnosis, and prognosis. This area of inquiry can bear immediate results because i) molecular evolutionary theory and methods are established for the study of genetic variation within populations and across species, and, ii) despite many efforts to profile the genetic basis of disease, the heritability of many common diseases is generally undiscovered, and the imminent arrival of personal genomics in the clinic has engendered a pressing clinical need to establish robust methods and clinical insights for the clinical interpretation of patterns of genetic variation presenting in a patient's individual genome.

An important aspect of the present disclosure is that position-specific evolutionary anatomies derived for each position in the human genome can be used to inform and improve the discovery and clinical assessment of disease-associated variation in individuals and populations by establishing quantitative priors on their propensity to affect human health. Position specific evolutionary anatomies are discussed as evolutionary features that can be derived for any position in the human genome using cross-species comparative genomics.

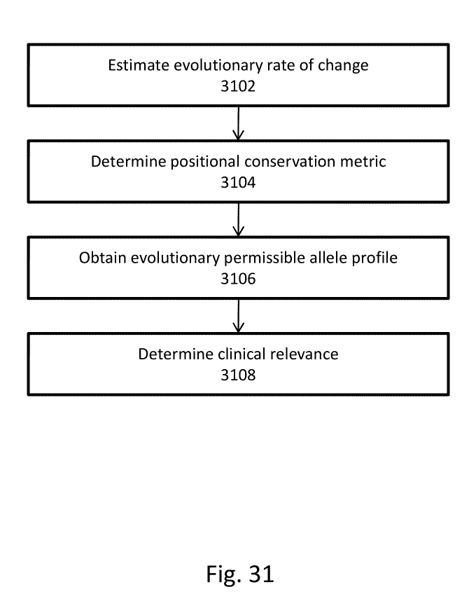

Shown in FIG. 31, is a block diagram of a method according to an embodiment of the present invention for functional evolutionary assessment of genetic variants presenting in a personal genome. Among other things, certain embodiments of the present invention include methods and techniques that estimate evolutionary prior parameters for each nucleotide in the human reference genome aligned to the genomes of other mammalian species having genome sequence information. For example in an embodiment of the present invention as shown in FIG. 31, at step 3102, an estimate for an evolutionary rate of change is determined. This estimate can be obtained using techniques and methods known to those of ordinary skill in the art but may also include new techniques as they are developed. For example, in an embodiment, the rate of amino acid or nucleotide change across species evolution is used. Further below, other examples are provided for estimating an evolutionary rate of change.

At step 3104, a positional conservation metric is determined. For example, in an embodiment, a metric is computed for retention of a position over distantly related diverged species. Other examples of such conservation metric are presented below, however, it is important to understand that other metrics and techniques are also possible while keeping within the teachings of the present invention. At step 3106, an evolutionary-permissible allele profile is obtained. In an embodiment of the present invention, alternate states of nucleotide and amino acid residues at a position among species is determined. Other embodiments are discussed further below.

At step 3108, the information obtained from steps 3102-3108, alone or in combination is used to establish prior expectations that an allele at a position will have clinical relevance.

The method of FIG. 31 is not intended to be limiting. In fact, those of ordinary skill in the art will understand that the disclosed steps can be performed in various orders. Indeed, alternative embodiments of the present invention can pipeline the computational steps of embodiments of the present invention. For example, where certain computations can be performed independently of others, parallel or multi-core processing can be implemented so as to improve the throughput of the present invention.

Other embodiments of the present invention incorporate functional data for human genomic regions extracted from public domain data, including, but not limited to, transcription factor binding data, differential gene expression, common disease variant associations, and expression quantitative trait loci (eQTL). Other data as may be currently available now or in the future can also be implemented while keeping within the teachings of the present invention.

In a method of the present invention, nominal and categorical features are extracted from the above-mentioned data sets, for example, and integrated with estimated evolutionary priors to construct a set of features that are used to predict the functional effect of genetic variants. These features are used to build nucleotide-specific models. These features can also be used to build multi-allelic models that are predictive of allelic functional effects using an ensemble of machine learning algorithms including, but not limited to, gradient-descent logistic regression, naive Bayes, and random forests.

In an embodiment, given a novel variant or set of variants presented in an individual genome, the present invention is capable of, for example, generating a quantitative post-test probability that the variant is damaging to patient health as well as a set of likelihoods as to which diseases or physiological systems are impacted. In another embodiment, the present invention provides a quantitative, probabilistic assessment of variants in both coding and non-coding regions. Also, the an embodiment of the present invention provides quantitative assessments of genetic risk using models that simultaneously incorporate uncharacterized variants from multiple loci. The present invention further provides a probabilistic assessment and suggestion of disease or physiological system impact of observed variants diagnosed as damaging to patient health.

In other embodiments of the invention, features can be tuned to enhance accuracy for specific disease categories (e.g., autoimmune disease) by weighting or excluding various sets of evolutionary or functional features used in assessment of genetic variants.

The present invention provides advantages for use in health screening, clinical diagnosis and prognosis, preventative health assessment, preconception/carrier genetic testing, pre-implantation IVF genetic screening, clinical research, among other applications.

Among other things, the present disclosure will demonstrate evaluations of the assumptions that go into estimation and use of evolutionary prior information, and demonstrate the utility of evolutionary prior information for evaluating common disease variants and variants linked to pharmacogenomics response in individual patients. Among other things, the following issues will be discussed.

Null Evolutionary Hypothesis for Genomic Medicine

Both modern and historical perspectives on the role of evolution in human health are full of scientific folklore speculating adaptive evolutionary origins of human diseases. This continued even with the discovery of genomic underpinnings of human maladies. Among other things, the present disclosure establishes a common framework illuminating the power and pitfalls of evolutionary thinking in genomic medicine as a prerequisite for empirical and intellectual unification of evolution and modern medicine. Below, evidence is reviewed that points towards the classical Neutral Theory of molecular evolution, which explains population and species variation profiled at the molecular level in humans and their evolutionary relatives, as the basis for a sound framework for evaluating evolutionary hypotheses in health and medicine. The Neutral Theory has been shown to explain the origins and distribution of Mendelian and complex disease mutations and also to establish limits on the ability of evolutionary genomics to explain and diagnose the molecular basis of human diseases. A neutral evolutionary perspective provides medical practitioners with a clinically informative and actionable evolutionary framework, which enables objective clinical assessment far beyond convenient tendencies to speculatively invoke past adaptive events in human history as a root cause of human disease.

Cross-Species Positional Evolutionary Priors to Inform and Improve Discovery of Disease-Associated Variants

Genome-wide disease association studies contrast genetic variation between disease cohorts and healthy populations to discover single nucleotide polymorphisms (SNPs) and other genetic markers revealing underlying genetic architectures of human diseases. Despite many large efforts, these studies are yet to identify many reproducible genetic variants that explain significant proportions of the heritable risk of common human diseases.

Presented below are results from a multispecies comparative genomic meta-analysis of 6,720 risk variants for more than 420 disease phenotypes reported in 1,814 studies, which is aimed at investigating the role of evolutionary histories of genomic positions on the discovery, reproducibility, and missing heritability of disease associated SNPs (dSNPs) identified in association studies. It is shown in an embodiment of the present invention that dSNPs are disproportionately discovered at conserved genomic loci in both coding and noncoding regions, as the effect size (odds ratio) of dSNPs relates strongly to the evolutionary conservation of their genomic positions. These findings indicate that association studies are biased towards discovering rare variants, because strongly conserved positions only permit minor alleles with lowest frequencies. Using published data from a large case-control study, it is demonstrated in an embodiment that the use of a straightforward multispecies evolutionary prior improves the power of association statistics to discover SNPs with reproducible genetic disease associations. Therefore, long-term evolutionary histories of genomic positions play a key role in reassessing data from existing disease association studies and in the design and analysis of future studies aimed at revealing the genetic basis of common human diseases.

Cross-Species Positional Evolutionary Priors to Inform and Improve Discovery and Clinical Assessment of Pharmacogenomic Variation

A key challenge in pharmacogenomics is the identification of genetic variants underlying differential drug response phenotypes, which can include severe adverse effects. Pharmacogenomics GWAS attempt to elucidate genotypes predictive of drug response by measuring genetic variation between populations of normal and abnormal drug responders. The typical size of these studies, however, has severely limited their power to discover variants thereby limiting their potential clinical application. In this work, a knowledge integration and SNP aggregation approach is disclosed for identifying gene-associated genetic variants impacting drug response.

An SNP aggregation method in an embodiment of the present invention characterizes the degree to which uncommon alleles of a gene are associated with drug response. Because human population allele frequencies are a function of the evolutionary context of a genomic position, position-specific evolutionary priors are computed across species in a scoring method to weight observed allele frequencies relative to their expected functional impact. This method of the present invention was applied to a published warfarin GWAS data set comprising 181 individuals. This method of the present invention can increase the power of the GWAS to identify both VKORC1 and CYP2C9 as warfarin pharmacogenes, where the original GWAS analysis had only identified VKORC1. Additionally, this method of the present invention can be used to discriminate between low-dose (AUROC=0.88) and high-dose (AUROC=0.76) responders with appreciable accuracy. The results support the use of this approach as a new route for pharmacogenomics variant discovery and assessment, and offer support for the use of cross-species evolutionary features of genomic positions in the clinical assessment of pharmacogenomic variation.

Null Hypothesis for Evolutionary Medicine Based on the Neutral Theory of Molecular Evolution

Since the announcements of Darwin's great discovery in the 19th century, scientists have been excited about the applications of evolutionary principles into medicine. The interface between evolutionary biology and medicine became apparent after the establishment of DNA in the 1950s as the hereditary material and the DNA sequencing revolutions in the last two decades. Scores of investigations have highlighted the potential of applying evolutionary principles in human health and disease, including recent evolutionary insights into the origins of lactose tolerance and malaria resistance, for example. The potential to apply evolutionary methods and principles towards clinical utility is gaining in significance with increasing public availability and declining production costs of whole genome and exome sequence data measured from individuals and populations. Even efforts to incorporate evolutionary biology into medical education are now underway and growing.

As the interface between evolutionary biology and genomic medicine progresses into the mainstream of clinical research and training, it is important to establish empirical and theoretical frameworks based on sound null hypotheses against which all claims (e.g., alternative hypotheses) concerning the role or utility of evolutionary biology in medicine are scientifically evaluated. The classical Neutral Theory of Molecular Evolution (Kimura, M. The neutral theory of molecular evolution. (Cambridge University Press, Cambridge [Cambridgeshire]; New York; 1983)) provides a ready framework for generating null hypothesis needed for the discovery, characterization, and clinical evaluation of human disease-associated variation.

For the past fifty years, the Neutral Theory has firmly established principles that explain the fate of new mutations in a population and the emergence of differences within and among species. Further, it has served as the fundamental basis for developing groundbreaking methods for identifying genomic tracks of adaptive change, predicting functionally important parts of the human genome, timing the origins of novel genes and mutations, and finding genomic elements that associate with human diseases. Here, evidence is disclosed indicating that the primary tenets of the Neutral Theory also explain the nature and emergence of disease mutations and diseaseassociated variants in modern human populations. Elaboration is made on the clinical implications of this neutral theory perspective, which integrates population and species evolution patterns for better diagnosis and treatment of human diseases with an etiological basis in genetic mutations.

### Neutral Theory for Medical and Personal Mutations

Neutral theory provides a theoretical framework for understanding the origins and fate of variation within a species, including humans. The primary forces that give rise to and maintain variation within populations are mutation, recombination, and random genetic drift. Mutations are de novo genomic alterations in an individual, which when passed on to offspring through the germline (e.g. sperm and eggs), may contribute to disease. Recombination is the process of breaking up of associations between alleles that co-occur on the same chromosome, which can lead to or dissociate detrimental juxtaposition of allelic variants. Finally, random genetic drift is a process that dictates the fate of a newly arisen mutation over time in a population. Due to random genetic drift, many mutations with no detrimental effects (e.g., neutral mutations) will reach high frequency in a population and appear as differences among populations and species.

All population, personal and disease-associated variants observed today have been subjected to and their frequencies are a product of these forces, and their unification under Neutral Theory provides the theoretical basis upon which hypotheses about the distribution of these mutations—including simple, complex, mitochondrial, and somatic disease-associated mutations—can be developed and evaluated.

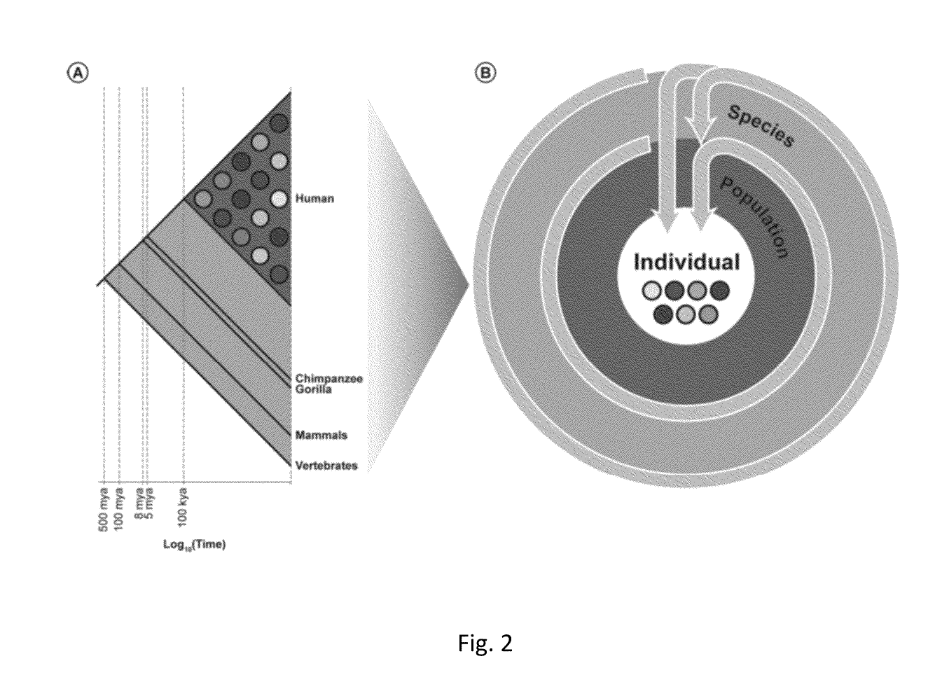

Neutral Theory allows for inference across levels of organization: from personal to population, from population to species, and from species to deeper evolutionary history of humans and their evolutionary cousins (FIG. 2). Therefore, macroevolutionary (species) patterns are intimately linked with microevolutionary (population) patterns. This is different from contemporary discussions in Evolutionary (and Darwinian) Medicine of health and diseases, which have placed greater focus on human population histories and historical environments in understanding the root causes, and have not highlighted the subject of macroevolution for medical perspective. In an embodiment, the Neutral Theory framework enables one to unify population and species evolutionary dynamics to construct a broader evolutionary medicine framework. Some recent findings illustrate this fact, which are discussed below.

FIG. 2 is a schematic diagram showing the macroevolutionary (long-term) and microevolutionary (short-term; within population) context of personal genomes.

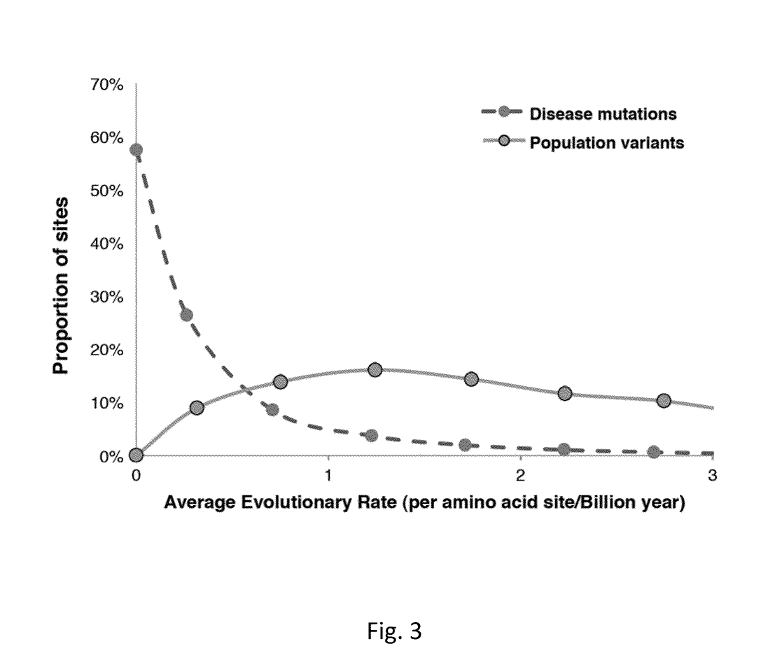

Neutral Theory asserts that a vast majority of mutations are deleterious in nature and will consequently be eliminated from the population. This means that the majority of variants observed in modern populations will generally be neutral, especially those in homozygous states. Accordingly, loci harboring high proportions of neutral alleles should also be evolving at relatively high rates due to reduced evolutionary constraint. It is then expected that putatively causal disease variants in functional regions (e.g., protein-coding regions) would be observed disproportionately at slow evolving positions in the genome, which are constrained by purifying selection. Empirical studies using large samples of Mendelian disease-associated and neutral variation data support these expectations (FIG. 3).

FIG. 3 is a chart of the distribution of evolutionary rates of positions harboring Mendelian diseaseassociated mutations and population polymorphisms according to an embodiment of the present invention. A vast majority of disease mutations occur at highly conserved positions (lowest rates of evolution), whereas population polymorphisms occur preferentially at fast-evolving positions (most variable). These distributions are based on inter-species evolutionary rate estimates in Kumar et al. (Kumar, S. et al. Positional conservation and amino acids shape the correct diagnosis and population frequencies of benign and damaging personal amino acid mutations. Genome research 19, 1562-1569 (2009)) for 9,460 disease and 12,421 population polymorphisms. Evolutionary rates are in the units of substitutions per amino acid per billion years and are based on protein sequence alignments available from the UCSC resource (Lohmueller, K. E. et al. Proportionally more deleterious genetic variation in European than in African populations. Nature 451, 994-997 (2008)).

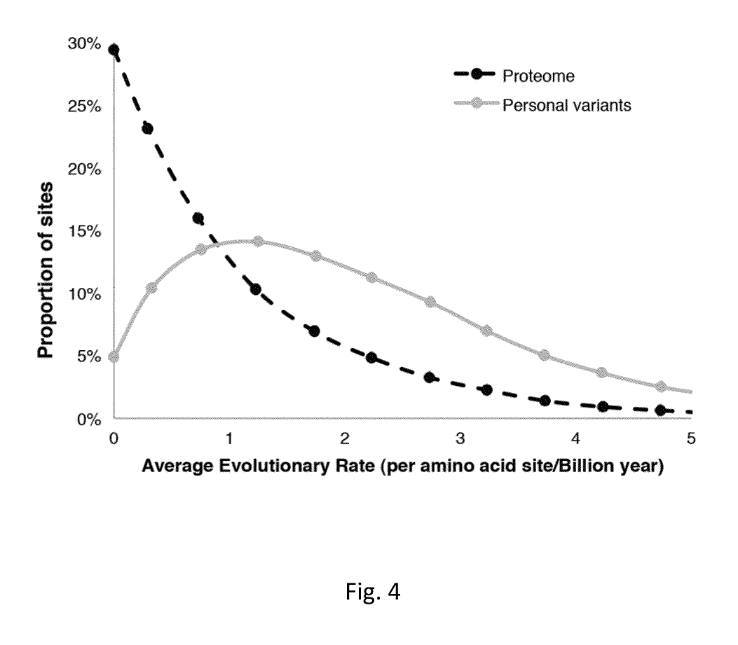

As a corollary, one would expect personal (e.g., rare) variants to be observed disproportionately at positions that are less evolutionarily constrained, which is also seen in empirical data (FIG. 4).

FIG. 4 is a chart of evolutionary rates of amino acid sites harboring personal variants in four completely sequenced human genomes according to an embodiment of the present invention. The distribution of evolutionary rates for positions harboring coding variants from personal genomes (green circles) is contrasted with the distribution of proteome-wide evolutionary rate distributions (dashed line). Personal genomes analyzed were: Venter (Levy, S. et al. The diploid genome sequence of an individual human. PLoS Biol 5, e254 (2007)), Watson (Wheeler, D. A. et al. The complete genome of an individual by massively parallel DNA sequencing. Nature 452, 872-876 (2008)), Korean (Wang, J. et al. The diploid genome sequence of an Asian individual. Nature 456, 60-65 (2008)), and Yoruban (Bentley, D. R. et al. Accurate whole human genome sequencing using reversible terminator chemistry. Nature 456, 53-59 (2008)). Rate distributions are based on estimates from 100,000 randomly sampled positions in the human proteins and a pooled set of 31,001 personal mutations from the four genomes.

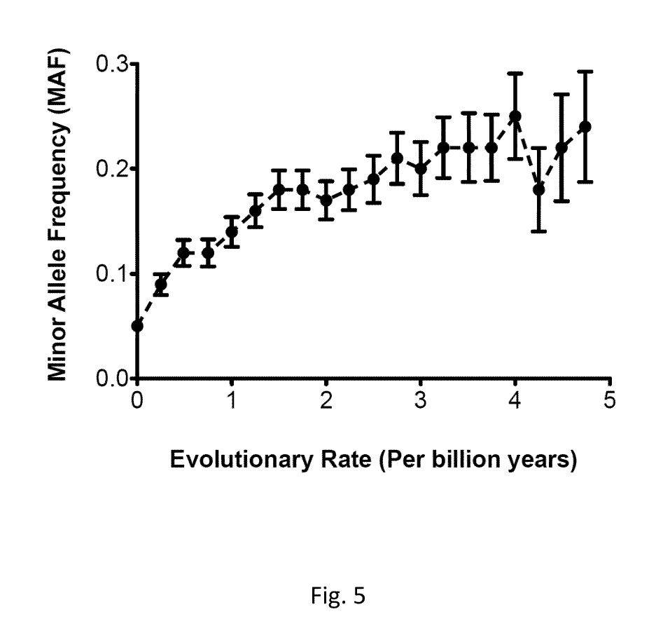

Neutral Theory also implies that frequencies of population polymorphisms will be modulated by long-term evolutionary rates based on evolutionary differences found among species, which ultimately manifests in the observed mutations in personal genomes and population alleles (FIG. 5). The strong empirical support for expectations and evolutionary interpretations of genetic variation patterns asserted under Neutral Theory supports its utility in setting baseline expectations for the clinical assessment of population variation and personal mutations found in patient genomes.

FIG. 5 is a chart of the relationship between cross-species evolutionary rate and minor allele frequency in modern human populations according to an embodiment of the present invention.

### Neutral Theory And Adaptive Origins of Disease Mutations

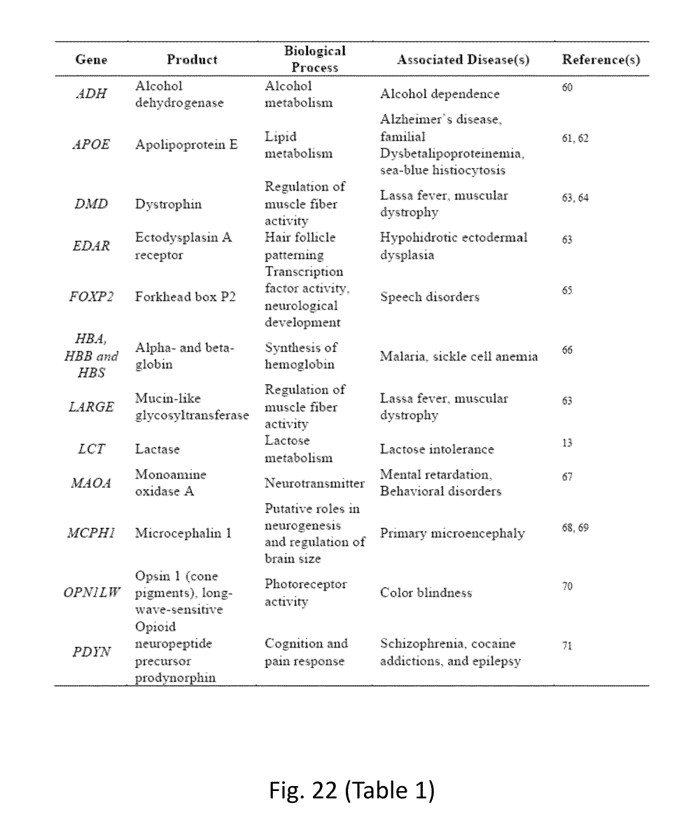

Despite the fact that the Neutral Theory can readily explain many properties of mutations that exist in contemporary general and clinical populations, many narratives on the interplay between evolution and human health have been focused on a few detrimental mutations that are found in appreciably high frequencies (MAF >5%) in modern human populations (FIG. 22 (Table 1)). These high-frequency disease-associated variations are thought to be the result of past adaptive events, which have become detrimental in the modern contexts. For example, a long-held adaptation-oriented view on the evolutionary origins of obesity draws from the thrifty gene hypothesis, which suggests metabolic adaptation was driven by periods of food scarcity in hunter-gatherer populations. This view asserts that obesity prevalence in modern populations is a result of thrifty-adapted metabolisms experiencing food abundance.

FIG. 22 (Table 1) is a table of examples of genes harboring human disease mutations for which empirical molecular evidence supports a putative role for positive natural selection acting on emerged gene variants according to an embodiment of the present invention.

The selection for previously adaptive mutations is only one possible evolutionary explanation. Many non-adaptive mutations are also expected to rise to high frequency within a population, because random genetic drift dictates the fate of any mutation with no significant negative effects (e.g., neutral mutations). Many of these neutral and high frequency alleles may also contribute to human diseases today because the neutrality of an allele depends on its genomic and environmental contexts. Population migration and genetic admixing can disrupt neutrality of a mutation, subjecting it to natural selection.

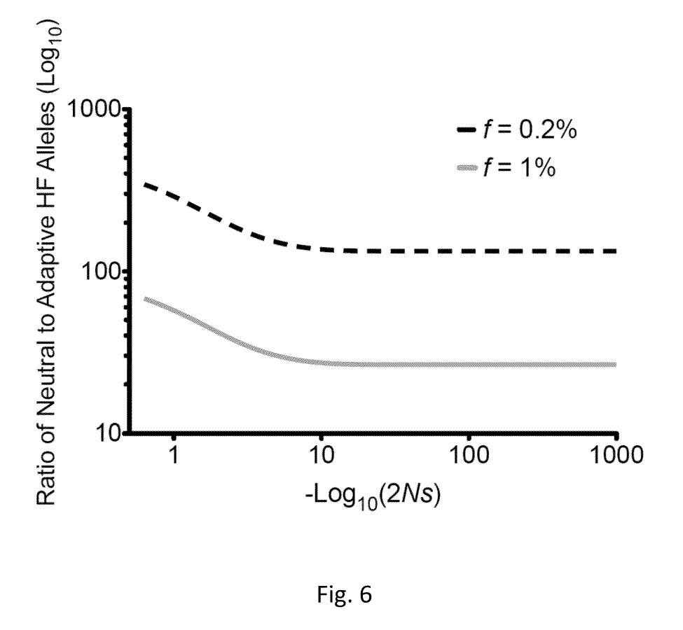

Therefore, historically neutral variations, including those that have reached high frequency in a population, may become suboptimal. These previously neutral, high frequency variants far exceed the numbers of high frequency adaptive alleles by an order of magnitude even under the most adaptively optimistic assumptions (FIG. 6). In addition, many contemporary population variations were neutral and reached high frequencies when individual fitness was determined by environmental challenges in early life stages, but may exhibit damaging effects at later stages of adulthood today because of increased life spans. Because the intensity of selection on an allele will decline proportionally to the lifespan age at which it is expressed, accumulation of weakly deleterious alleles may additively contribute to disease late in life.

FIG. 6 is a chart of the relative frequency of neutral to adaptive mutations that will reach high frequency (HF: 50%-90%) in a population according to an embodiment of the present invention. The figure shows that more than an overwhelming majority of HF mutations will be neutral even when the adaptive mutations have very high selective advantage (s, increment of fitness; N, effective population size) relative to the wild-type allele.

Evolutionary adaptations in human history favored mutations that conferred higher fitness to populations in specific environmental and life history contexts, and individuals carrying historically adaptive mutations to another region may be adversely affected. Only a few clear-cut examples of such mutations are known to date (Table 1), and even these few examples have not gone uncontested. The paucity of such examples would be expected in light of the trends seen in FIG. 6. Using the population genetics aspects of the Neutral Theory, one can assess the relative contributions of previously neutral versus previously adaptive mutations, and test whether past episodes of (positive) natural selection are contributing to disease today. Over the last few years, population genomic studies have found only a relatively minor role for adaptation in the emergence of disease-associated alleles.

Recently, Hernandez et al. (Hernandez, R. D. et al. Classic Selective Sweeps Were Rare in Recent Human Evolution. Science (New York, N.Y.) 331, 920-924 (2011)) looked for evidence of classic selective sweeps using resequencing data for 179 human genomes. They found that genomic diversity around human lineage specific amino acid substitutions was no more pronounced than that around synonymous substitutions, and that genomic diversity around amino acid sites and putative regulatory regions was not substantially different than the genomic background, nor were they enriched for alleles that segregate among populations—ultimately suggesting that classic selective sweeps for adaptive alleles were rare in human evolution. Even the often-assumed adaptive origins of obesity have garnered little support in the face of population genomic and epidemiological data available today.

Although Neutral Theory expects adaptive alleles to comprise only a small fraction of observed variants in a population, they are embraced by the theory and expected to have important functional consequences. The development of many approaches for detecting signals of recent positive selection have yielded notable findings, including recent selection in the Lactase (LCT) gene, which allows some human populations to digest lactose into adulthood and adaptations associated with response to infectious disease.

Because of these few but compelling findings, adaptive explanations have taken hold as a popular evolutionary modality for genome-wide discovery of novel traitassociated loci in the human genome. It is expected that most clear signatures of genomic adaptation in humans would likely be attributable to specific local environments (e.g., cattle domestication and malaria epidemics). If this is true, then these local adaptations will not necessarily have significant implications for disease, because all subpopulations with different environments carry their own landscape of neutral alleles—unless individuals become adversely “misplaced” through recent migration (e.g., sicklecell anemia in African American population) or there is change in local environment. Also, when an adaptive allele is in the process of spreading in a given population, nonexpression of the adaptive trait is not necessarily deleterious, because the starting population with the former wild-type allele may not have been seriously unfit. It is, however, plausible that extreme pressures on fitness, such as emergent infectious agents, could impose strong negative selection on wild-type alleles, and may expose deleterious cryptic variation through decanalization.

Adaptive mutations are likely to underlie a small portion of human genetic diseases, particularly with regards to infectious disease, or through antagonistic pleiotropy. These adaptive explanations must take the form of alternative hypotheses that are to be rigorously evaluated against a neutral null hypothesis. The ultimate achievement of a null hypothesis for human disease mutations founded in Neutral Theory is to unify evolutionary biology, genomics and modern evidence-based medicine, for example, as shown in FIG. 1. In this way, evolution serves not as a pathological ghost of human history, but rather as a powerful framework for translating fundamental discoveries into clinical utility towards improved patient outcomes.

### Neutral Evolution as a Tool to Diagnose Contemporary Mutations

Distinguishing harmful variations in personal genomes from those with benign effects during an individual's life course is a challenge in Genomic Medicine and personal genomics. Due to advances in sequencing technologies, medical practitioners will soon be asked to diagnose mutations in a patient's genome in addition to their physiological symptoms, as is already being asked of them by patients bearing results from direct-toconsumer genotyping services. Presently, the complete genomes and exomes of hundreds of individual humans have been sequenced to large extents, and projects are underway to expand these numbers to over tens of thousands. Consequently, it has been learned that each personal genome carries thousands of protein mutations, many of which occur in genes associated with disease.

Clinical assessment of a patient incorporating a personal genome has the promise of improving the overall appraisal of a patient's health risks, and guide clinical decisionmaking regarding lifestyle and therapeutic intervention. Such efforts also highlight the substantial clinical challenges posed by rare and novel variants present in a patient's genome. Without any means to establish prior expectations of clinical significance on such variants, their incidental discovery may cause the patient to be subject to unnecessary follow-up examinations. There is an impending clinical need to be able to sort through the mutations in individual human genomes, and highlight those that are most likely to have a consequence for an individual's health or course of clinical care.

Experimental or clinical evidence regarding the consequence of mutations even commonly observed in the population is often lacking, and recent, high-throughput efforts to identify common disease variants through Genome Wide Association Studies (GWAS) have so far offered limited clinical utility. Consequently, in silico approaches are used to predict whether a mutation will have negative effect on protein function. A large number of computational tools for predicting the functional effect of mutation have been published, each incorporating an increasing large number of clinical or biological attributes into their algorithms. Although designed primarily for analysis of coding mutations in candidate genes, these tools are now being utilized for genome-wide scans of coding polymorphisms. With predictive accuracies averaging 60-90%, these tools perform well for the purpose of generating biological hypotheses, but these tools frequently produce discordant clinical diagnoses even for simple (monogenic) diseases—as much as 95% discordance when applying just three popular methods to complete individual genomes. Therefore, there is a strong need to improve the accuracy of in silico tools for the purpose of clinical diagnosis.

Long-term evolutionary histories of species, which largely capture neutral evolutionary trends over the millennia, help to establish a priori expectations of functional effect, because each position in the genome has undergone functional evaluation across species evolution. The accuracy of in silico tools was found to be directly related to the evolutionary context of the position where they occur. The in silico tools are found to be least accurate at fast-evolving positions, which would be predicted to harbor mostly benign mutations under the Neutral Theory. While most in silico tools already incorporate evolutionary information in their algorithms, there is room for improving the prediction accuracies by more effective use of evolutionary information. Evolutionary expectations might also forecast positions and mutations for which in silico tools will be the most effective for clinical diagnosis. The clinical utility of current tools is further restricted by the fact that they are only capable of assessing mutations found in protein-coding regions. This limitation is likely attributable to the lack of functional data for non-coding regions, but recently available data from disease association studies and high-throughput functional genomics studies across species can enable testing of evolutionary hypotheses for disease mutations in non-coding regions.

It is important to explore limitations in the use of evolutionary information as a tool for diagnosing mutations. For instance, early studies suggest that the evolutionary profiles of complex disease mutations are very similar to those of population polymorphisms found at large, and may be difficult to distinguish from an evolutionary perspective. It is important to differentiate the distinct long-term evolutionary profiles of positions and mutations involved in Mendelian (monogenic) disease traits from those underlying complex diseases in order to identify situations in which evolutionary information will be informative. Although complex diseases are likely to have substantial non-genetic components through environmental influences, much of the genetic heritability of common disease traits remains to be discovered.

The Neutral Theory provides a framework to formulate prior expectations regarding this “missing” heritability. For example, some recent studies based on evolutionary modeling suggest that the majority of variants contributing substantially to the genetic variance of complex diseases are rare alleles found at very low population frequencies. This is largely expected under Neutral Theory and may explain some inability to detect causal variants through association studies. As more complete genomes and exomes begin to emerge in the public domain, direct evaluate many evolutionary hypotheses are possible towards the establishment of empirical priors for clinical discovery and diagnosis.

### Healthy Perspective on Evolution in Medicine

At this point, it is important to address the role that populist perception might play in the acceptance of evolutionary thinking in medicine. Perhaps the most unfortunate consequence of a purely adaption-oriented view of human disease mutations is the belief that evolution serves as a wellspring for many facets of ill health. Some protagonists of this view have even been so bold as to declare which specific “failures” of evolutionary adaptation have caused specific diseases in modern populations. Evolution is not the source of illness but rather it is the source of robustness and the reason that humans have evolved to thrive so successfully under a broad range of conditions. Also concerning is the minority assertion that evolution has somehow “stopped” for humans because modern medicine and lifestyles have slowed adaptation. A neutral perspective asserts, with overwhelming support from existing data, that the drumbeat of evolution continues in modern populations irrespective of differences in the fitness landscapes between modern and ancient human populations. In this way, evolution gains relevance on par with other continuous factors influencing individual health, such as behavior and environment.

A crucial step towards integrating evolution and medicine lies in orienting empirical findings from evolutionary studies such that they are easily translated towards clinical application. In addition to understanding the patterns and processes about contemporary variation and diseases, evolutionary community will need to keep in sight the fact that the yardstick of medicine is clinical utility. In this vein, the “best” use of evolutionary explanation for human disease-associated variations is the one that produces the greatest clinical utility. For example, an evolutionary understanding of the failure rate of in silico diagnosis may help to understand, a priori, when a reliable decision could be made.

Because long-term (e.g., across species) evolutionary quantities can be estimated for each position in the human genome independent of human populations (FIG. 2), there is potential to use positional evolutionary information as priors in population-based studies of human disease having an etiological basis in human mutation. Although modern Genome Wide Association Studies (GWAS) operate under the assumption that all measured loci are equally likely to harbor alleles that segregate between healthy and disease affected populations, it is known from the empirical data and established evolutionary principals that the expected population allele frequency spectrum for both ancient and derived alleles is tied to the evolutionary history of positions and that certain categories of disease mutations have a propensity to be found at sites with particular evolutionary histories. New types of association statistics that incorporate evolutionary priors can have increased power to discover reliable disease-associated loci from both published and future genetic disease association studies.

Methods

### Evolutionary Rate Estimation

In an embodiment of the present invention, evolutionary rates were estimated using the method described in Kumar et al., which is based on the Fitch parsimony method (Fitch, W. M. Toward Defining the Course of Evolution: Minimum Change for a Specific Tree Topology. Systematic Zoology 20, 406-416 (1971). 117. Sawyer, S. A. & Hartl, D. L. Population genetics of polymorphism and divergence. Genetics 132, 1161-1176 (1992)). Evolutionary rates are in the units of substitutions per amino acid per billion years and are based on protein sequence alignments available from the UCSC resource.

### Allele Frequency Data

In an embodiment of the present invention, data used to derive the evolutionary rate vs. MAF plot (FIG. 5) was obtained from Lohmeuller et al. (Lohmueller, K. E. et al. Proportionally more deleterious genetic variation in European than in African populations. Nature 451, 994-997 (2008)).

### Neutral Vs. Adaptive High-Frequency Allele Simulation

The expected proportion of high-frequency (HF: 50%-90%) neutral and adaptive polymorphisms were estimated by using the equations 11 and 12 of Sawyer and Hartl (Sawyer, S. A. & Hartl, D. L. Population genetics of polymorphism and divergence. Genetics 132, 1161-1176 (1992)), which describes the equilibrium flux of mutant alleles reaching high frequency in a population of effective population size 2N. For simplicity, only neutral and adaptive mutations were considered in these calculations, because deleterious mutations are unlikely to rise to high frequencies (>50%). Note that the increasing 2Ns will not increase the proportion of adaptive HF polymorphisms, as the elevated probability of entering the high frequency range is balanced by shortening of the transient polymorphic period. It is important to note that a liberal upper bound has been used on the relative proportion of adaptive mutations (f=1%; dark line), but the actual fraction is expected to be smaller. So, the curve corresponding to the value of 0.2% (gray line) for relative proportion of adaptive mutations may be more realistic. Interestingly, the fraction of HF adaptive mutation is not expected to exceed 3.5% even when 1% of all new mutations in a population are adaptive and the adaptive allele has a very high s.

Revealing Ancient Constraints Affecting Discovery and Reproducibility in Disease Association Studies Through Evolutionary Meta-Analysis

In genetic disease association studies, millions of genomic loci are genotyped across large population samples of disease (case) and healthy (control) individuals, and genetic associations are determined by estimating the significance (P-value) and effect size (odds ratio) of the statistical relationship between alleles at genetic loci and a disease trait. To date, thousands of putative disease-associated genetic variants underlying complex disease phenotypes have been identified. Of these, a relatively small fraction has been reproduced in multiple studies, and consequently large proportions of the heritability for many diseases remains unexplained or “missing.” Non-additive effects of epistatic interactions, confounding influence of cryptic population stratification, effects of structural variants, synthetic associations with rare alleles, epigenetics, and gene environment interactions are among many hypotheses put forth to explain this missing heritability. Measurement of their absolute contributions to the problem of missing heritability is impeded by incomplete knowledge of the biochemical or physiological function of large portions of the genome, and their full evaluation may require collection of data from very large population samples of fully sequenced genomes.

In an embodiment of the present invention, an evolutionary approach is taken to investigating the problem of this missing heritability and lack of reproducibility in association studies, which has not been directly explored. This is likely due to the widespread realization that genetic variants underlying complex diseases will not impact fecundity because they occur relatively later in life. Still, molecular evolutionary patterns inform functional importance of genomic positions, as functionally important positions are likely to be more conserved and will directly impact the frequency of segregating alleles within populations under the neutral theory of molecular evolution. The widespread practice of direct comparison of association statistics (e.g., P-values and odds ratios) across genomic positions does not explicitly account for these evolutionary differences among genomic locations when identifying variants with the most significant disease associations.

### Methods

### SNP Datasets

In an embodiment of the present invention, data from the VARIMED database of quantitative human disease-SNP associations curated was used from the full text and supplementary info of 3,333 published human genetics papers recording more than 100 features per SNP association, including the disease name, specific phenotype, study population, case and control population information, genotyping technology, major/minor/risk alleles, odds ratio, 95% confidence interval of the odds ratio, published P-value, and genetic model. Studies on similar diseases are categorized and mapped to the appropriate concept term in the Medical Subject Heading (MeSH) hierarchy. For this embodiment, only single locus associations were considered and variants were excluded for which information on the effect size (odds ratio) was not available in the published results. Also excluded were disease-associated variants whose 95% confidence interval for the odds ratio included no effect (odds ratio=1), as the validity of the effect of such variants is uncertain. These criteria yielded a set of 6,720 variants associated with 420 disease phenotypes obtained from 1,814 published studies.

In an embodiment of the present invention, data was also obtained from a public catalog of disease associations curated from published GWAS, which is provided in downloadable format from http://www.genome.gov/gwastudies/ (accessed May 3, 2011).

Also, population genetic variation data from HapMap3 was retrieved from the HapMap Project FTP server (ftp://ftp.ncbi.nlm.nih.gov/hapmap/) (accessed Jan. 5, 2011). All SNPs were mapped to their genomic locations on hg19 release using NCBI dbSNP (hs130) identifiers.

### Estimation of Evolutionary Features

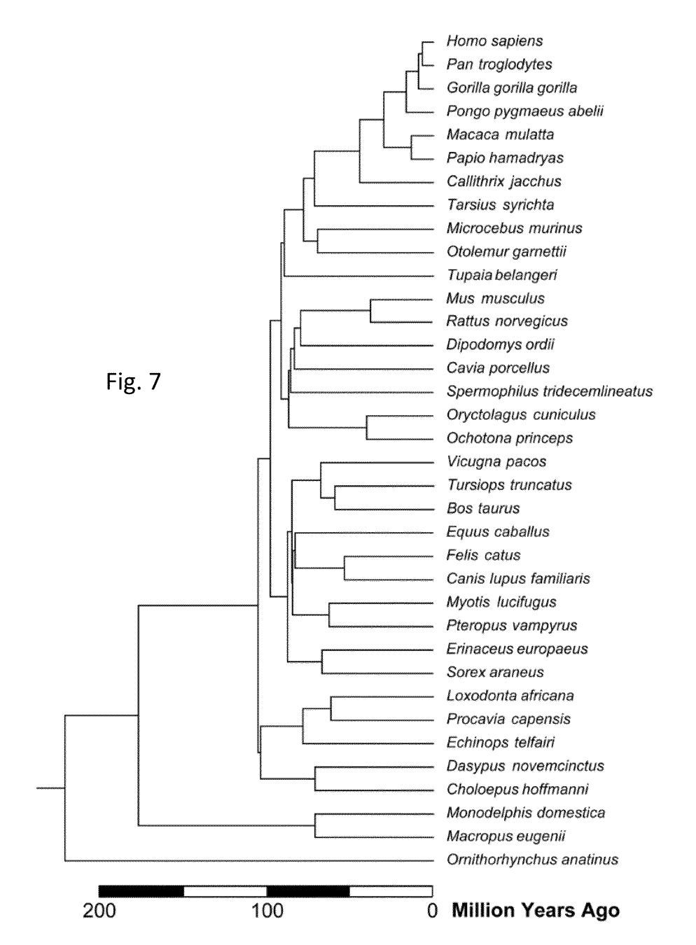

In an embodiment of the present invention, for each SNP, an evolutionary conservation score was estimated and the rate of substitution using nucleotide sequence alignments obtained from the UCSC genome resource was also estimated. In this embodiment, the evolutionary conservation score quantifies the fraction of evolutionary time among species for which the given human position has existed in the evolutionary history of the mammalian lineage (% ETS; FIG. 7). In this way, the evolutionary conservation relates to the retention of the genomic position, or positional conservation. In addition, the evolutionary rates of nucleotide change were estimated at each site by dividing the total number of substitution in the mammalian phylogeny by the total time elapsed on the tree (substitutions per site per billion years). For each position, species containing alignment gaps or missing data were pruned from the tree before calculating nucleotide substitution rates.

FIG. 7 is a timetree of 36 mammalian species used for deriving evolutionary information for each SNP. Species divergence times were obtained from www.timetree.org (Hedges, S. B., Dudley, J. & Kumar, S. TimeTree: a public knowledge-base of divergence times among organisms. Bioinformatics 22, 2971-2972 (2006)) according to an embodiment of the present invention.

### Evolutionary Analysis of WTCCC Data

In an embodiment of the present invention, the allelic P-value of association (P) for a SNP was modified using the evolutionary conservation score (E) of the position harboring the allele and the minor allele frequency (MAF) of the tagSNP: E-rank=(P/MAF)×(1-E). The rationale for this method is that segregating dSNPs linked with positionally conserved loci, quantified by E, should be given a greater weight than segregating dSNPs linked to more variable positions. In this embodiment, the P is divided by MAF because P is a function of both the MAF and the effect-size (e.g., odds ratio) of the associated allele. For example, if the WTCCC results were analyzed for Crohn's disease, across 500,000 loci the Pearson correlation between the log(P-value) and the log(odds ratio) is rather weak in effect (r=0.22, P<5e-16). The correlation between log(P-value)IMAF and the log(odds ratio) is much stronger (r=0.73, P<5e-16) with the variance from the allele frequency accounted for. Division by MAF is done to normalize the effect of the allele frequency and perform evolutionary adjustment on the remaining component.

In an embodiment, E-rank was applied to association data for 500,000 loci profiled across seven common diseases by the Wellcome Trust Case Control Consortium (WTCCC). LD estimates were used from the HapMap3 CEU population to associate each measured tagSNP with strongly linked loci using a linkage cutoff of r²≧0.8. All loci found to be linked to the tagSNP (linkage set) were assigned the association P-value of the respective tagSNP, and if multiple tagSNPs shared linked loci, the minimum (most significant) P-value was assigned. In an embodiment, evolutionary conservation was then estimated for each SNP in the linkage set and set E equal to the maximum percentile conservation across linked loci to generate the E-rank.

### Determination of a “Gold Standard” of Reproducible Disease Associations

To determine one set of reproducible SNPs in an embodiment of the present invention, the VARIMED disease SNP database was queried to identify SNP loci that were reported to be significantly associated with the relevant disease phenotype in three or more impendent studies in other Caucasian populations. These replicated SNPs were then mapped to the WTCCC study results by matching the dbSNP identifier (rsID) of the disease locus with either the tagSNP or the loci linked to the tagSNP.

In an embodiment, a more statistically stringent set of gold standard SNPs was determined using only those SNPs that have been replicated by independent studies more than once, or validated by meta-analysis below the strict P-value threshold of <5×10⁻⁸. This criteria yields a set of SNPs much smaller than the first set, but the very strict statistical criteria used to select these SNPs provides means to evaluate and ensure that methods according to embodiments of the present invention are not biased by SNP selection criteria. This strict set of disease associations were used to define gold standard regions, which were defined for each SNP as all other SNPs in linkage disequilibrium with the gold standard SNP with an r²≧0.05. These gold standard regions were used for evaluation to see how many regions were tagged by the top k SNPs prioritized by the P-rank vs. E-rank method.

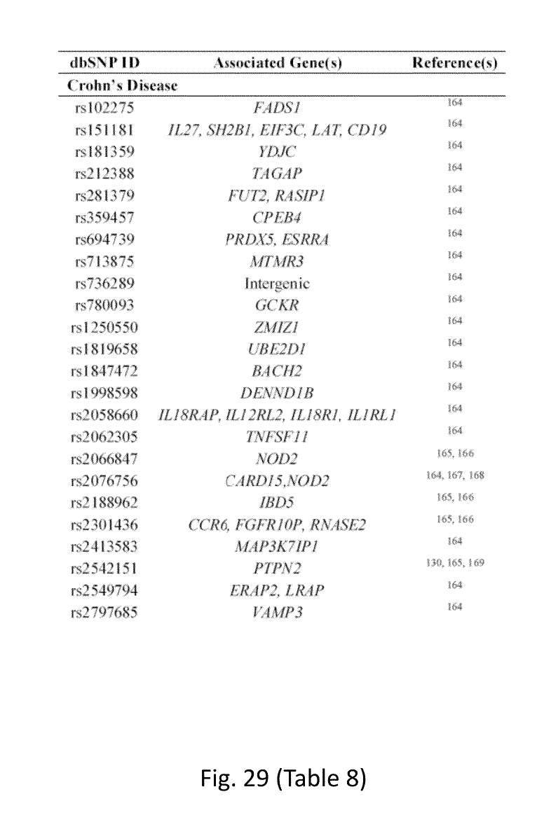

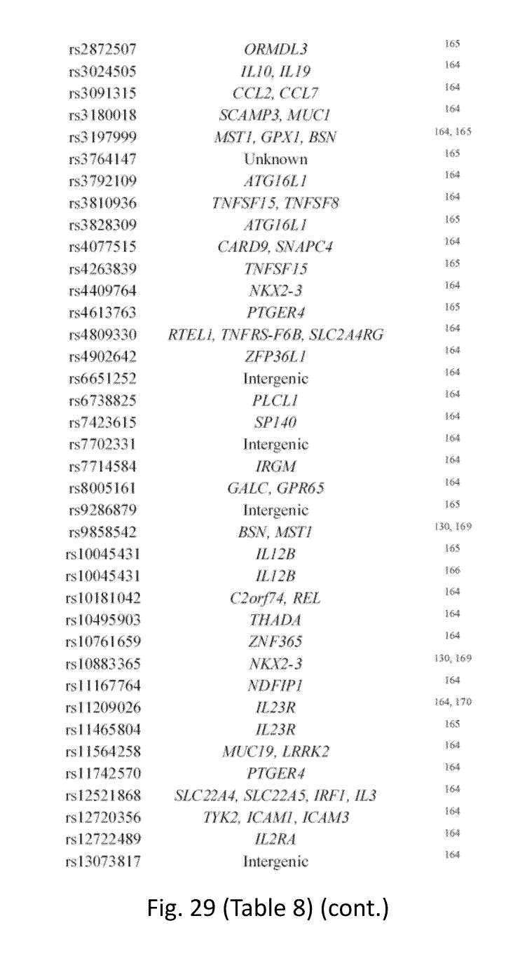

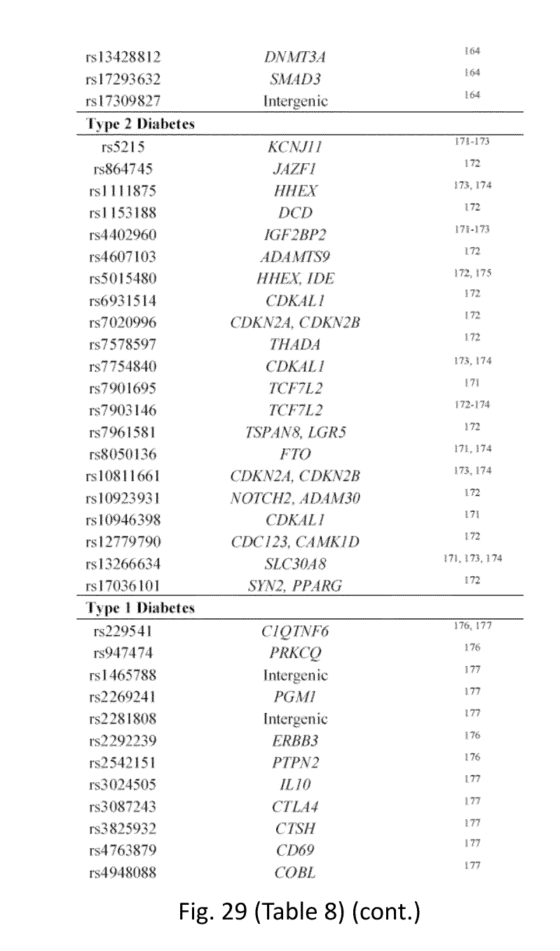

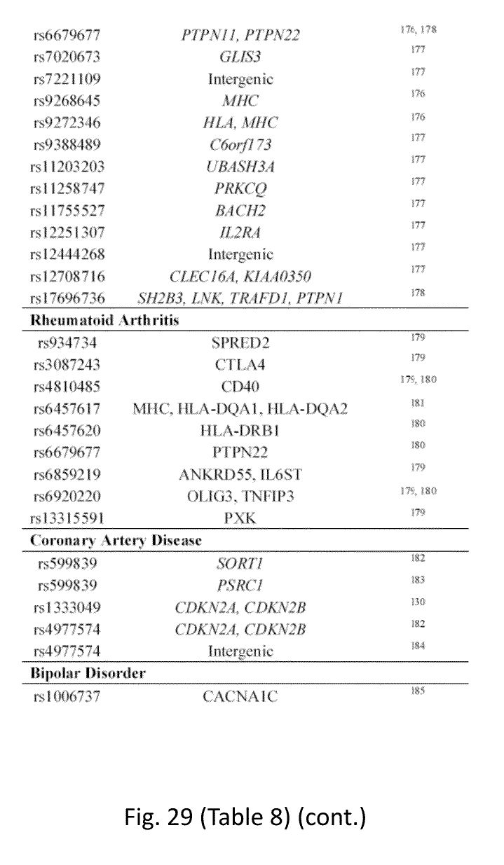

FIG. 29 (Table 8) is a table of gold standard disease SNPs according to an embodiment of the present invention. The tabulated SNPs were used for the gold standard set of stringent, reproducible disease associated variants discovered by genome-wide association studies. SNPs were selected for diseases represented in the WTCCC study using the criteria that the SNP had to be replicated in two or more studies, or by meta-analysis at the P<5×10⁻⁷ significance threshold.

### SNP Classification Problem

In an embodiment of the present invention, measured SNPs mapping to a “gold standard” replicated SNP by dbSNP identifier were assigned to the Replicated class and all others were assigned to the Unreplicated class. Note that this includes the directly measured SNP and any other SNP that could serve as a proxy SNP determined by the LD threshold (r²>0.8). Accuracy in distinguishing Replicated SNPs from Unreplicated was determined for each disease using the original allelic association P-value and the E-rank by estimating the area under the ROC curve (AUC) using the ROCR package. In this way the AUC relates to the likelihood that the study will rank a randomly selected locus with reproducible association (Replicated class) higher than a randomly selected locus with non-reproducible association (Unreplicated class).

### Results

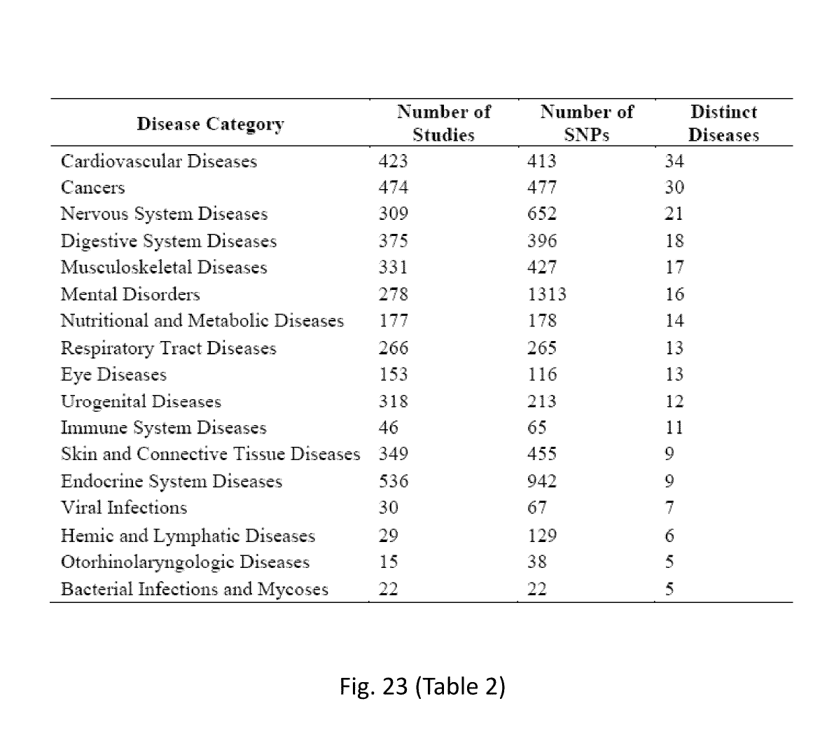

In an embodiment of the present invention, the relationship was systematically investigated between the evolutionary anatomies of positions harboring disease-associated variants for 6,720 SNPs (dSNPs) reported to be associated with more than 420 disease phenotypes (1,814 published studies) representing a broad range of complex disease categories (FIG. 23 (Table 2)), and the hypothesis was tested that the discovery of dSNPs is biased by the long-term evolutionary properties of genomic locations harboring dSNPs, which are inferred from multispecies alignments from diverse mammals (FIG. 7; Methods). FIG. 23 (Table 2) is a summary table of disease-associated variants used in the study according to an embodiment of the present invention.

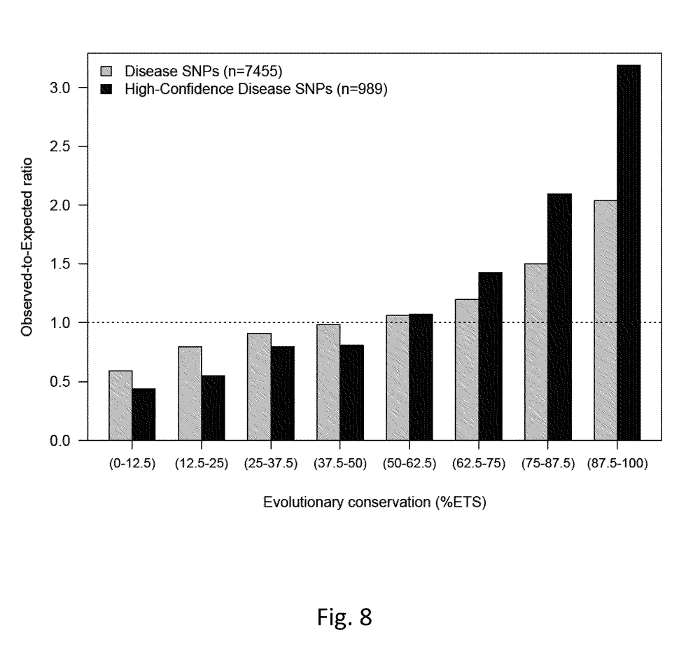

FIG. 8 is a chart of the relationship of the observed-to-expected numbers of disease-associated SNPs at different levels of evolutionary constraint according to an embodiment of the present invention. FIG. 8 shows the distribution of evolutionary conservation according to an embodiment of the present invention, estimated here as the percent evolutionary timespan (% ETS) over which the position is maintained (see Methods), for positions harboring risk variants reported to be statistically significant in at least one study (grey bars) and for a subset of dSNPs that were replicated in 4 or more studies and 3 or more distinct populations (high-confidence [HC] dSNPs, black bars). A considerable proportion of discovered variants are found at more conserved positions, with 53% dSNPs and 62% HC dSNPs at positions with >50% ETS, and their preponderance is greater than that expected based on the distribution of HapMap3 population SNPs (dotted line). FIG. 8 shows disease-associated SNPs (dSNPs) at human genomic positions preserved with different degrees of positional conservation (low-to-high is given left-to-right). Results from all dSNPs (grey bars) and high-confidence (HC) dSNPs (black bars) are shown. Expected numbers were estimated using 100,000 HapMap3 SNPs. The right axis indicates the fraction of total SNPs in each dSNP category that fall into the conservation bins defined on the bottom axis.

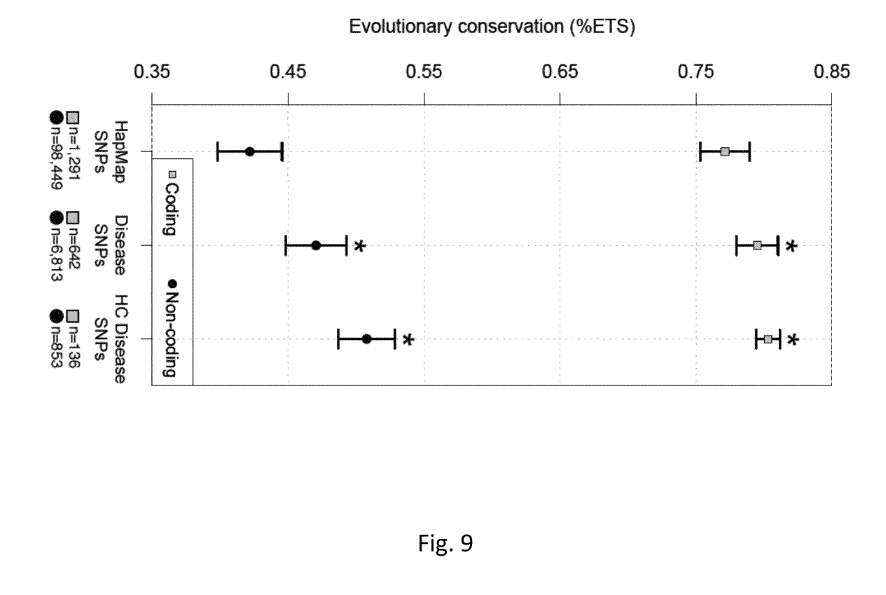

This pattern is also observed in separate analysis of coding dSNPs and non-coding dSNPs (FIG. 9). Coding dSNPs occur at more highly conserved positions than non-coding dSNPs, but the trend towards more conserved positions at disease associated loci is observed in both cases. These findings demonstrate that the dSNPs have been discovered disproportionately at positions that have been highly conserved over evolutionary time.

FIG. 9 is a chart of a comparison of average conservation of coding (grey squares) and non-coding (circles) dSNPs and high-confidence (HC) dSNPs to HapMap3 SNPs according to an embodiment of the present invention. SNPs in non-coding regions are overall found at much less conserved positions, however the mean conservation for non-coding significantly more conserved than non-coding HapMap SNPs. (Error bars: SEM) (* indicates t-test P-value <10⁻⁸ compared to HapMap3)

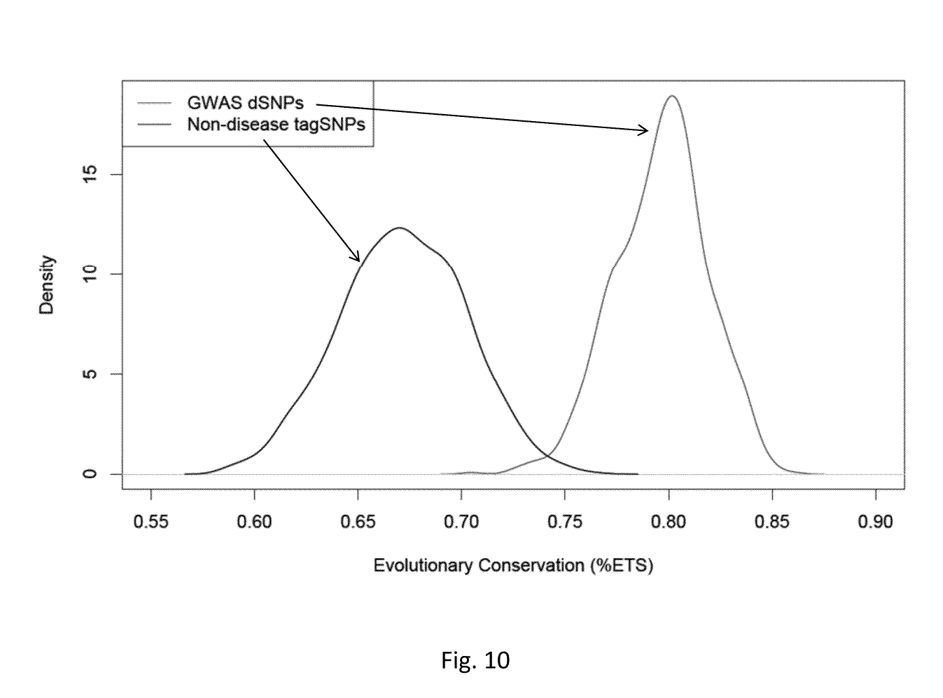

To ensure that the observed enrichment for disease associations at conserved positions was not a result of bias in SNP selection from targeted studies, the set of bona-fide GWAS SNPs that have been reproducibly associated at the threshold of P<5×10⁻⁷ or stronger was investigated. The same bias towards more conserved positions for these dSNPs is observed as well (FIG. 10).

FIG. 10 is a chart of the distribution of evolutionary conservation for GWAS dSNPs according to an embodiment of the present invention. The distribution of evolutionary conservation for a stringent set of bona fide GWAS dSNPs (red), associated at a stringent significance threshold of P<5×10⁻⁷ or lower in two ore more studies, is compared to the distribution of evolutionary conservation for tagSNPs found on the two most popular GWAS genotyping platforms. The mean evolutionary conservation for GWAS dSNPs is significantly higher than that of tagSNPs (t-test P<5×10⁻²⁰)

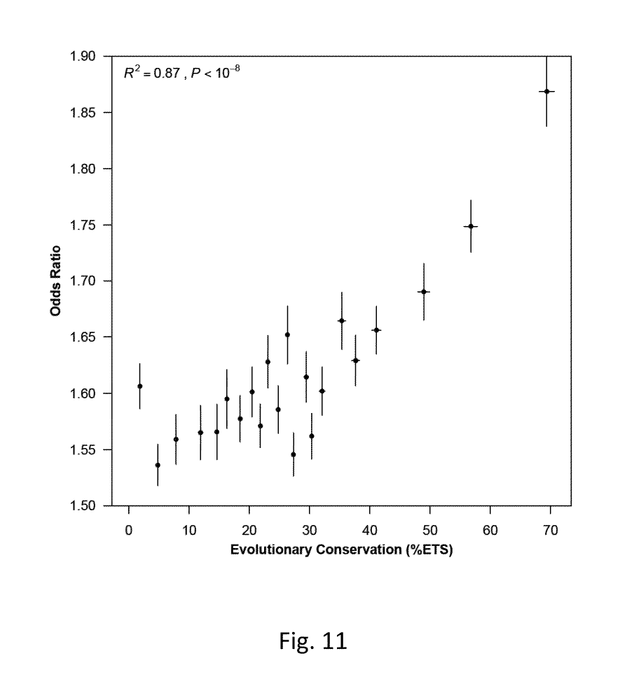

To assess the impact of this bias on heritability explained by dSNPs, the relationship was investigated between SNP association odds ratio and evolutionary conservation because the proportion of the genetic variance of a disease trait explained by a variant relates to the effect size (odds ratio) of association. It is observed that the reported effect size of diseaseassociated variants is strongly related to the evolutionary conservation of its genomic position (FIG. 11, R²=0.87, P<10⁻⁸).

FIG. 11 is a chart of the relationship between the odds ratio reported for disease associated variants and the evolutionary conservation of the genomic position harboring the variant according to an embodiment of the present invention. All reported odds ratios were normalized towards disease risk estimation by taking the exponent of the absolute loge of odds ratios <1. The trend was best described by a 2nd order polynomial (R²=0.87, P<10⁻⁸; Pearson r=0.86, P<10⁻⁴)

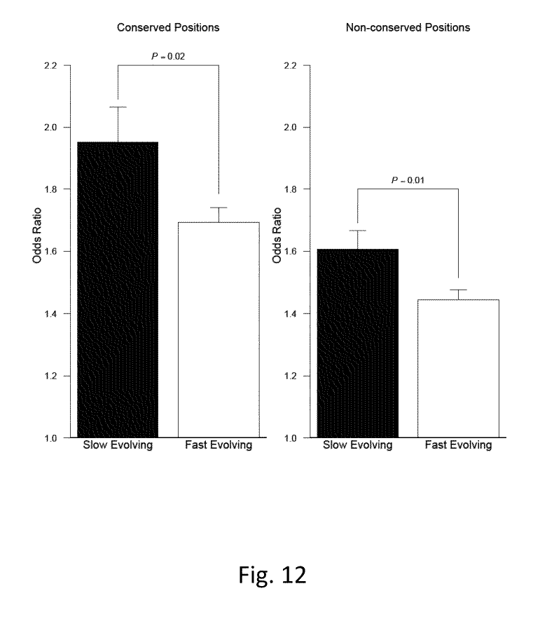

The rate of long-term evolutionary substitution of nucleotides also modulates the odds ratio distributions for dSNPs found at positions with high (top 25% conservation) as well as low (bottom 25% conservation) degree of conservation among species (FIG. 12). The quartile of the slowest evolving positions harbor dSNPs with higher odd ratios in association studies as compared to the quartile of the fastest evolving positions (P<0.05).

FIG. 12 is a chart of the relationship between odds ratio and evolutionary rate according to an embodiment of the present invention. Slowly evolving sites (bottom 25% of evolutionary rates) at highly conserved positions (top 25% of evolutionary conservation) exhibit higher average odds ratios than faster evolving sites (top 25% of evolutionary rates) at both conserved (top 25% ETS) and nonconserved (bottom 25% ETS) positions. (Error bars: SEM)

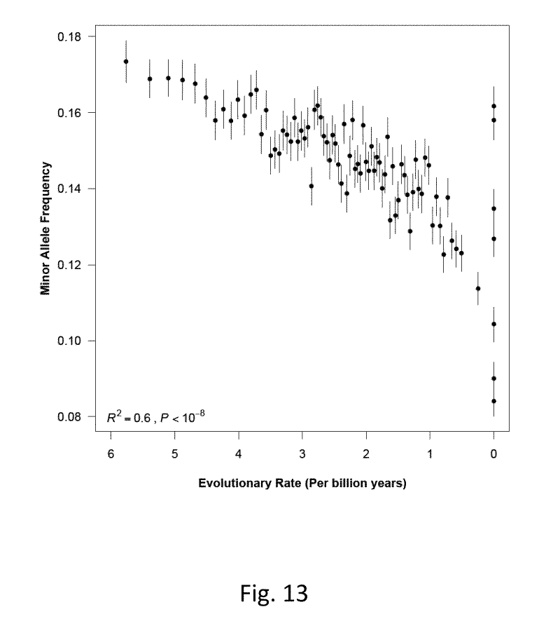

These observations provide a fundamental explanation for the preferential discovery of rare variants because slower evolving positions are expected to have lower minor allele frequencies due to stronger purifying selection (FIG. 13).

FIG. 13 is a chart of the relationship of the multispecies evolutionary rate with the minor allele frequencies (MAF) in human populations according to an embodiment of the present invention. Each point is estimated as the average of evolutionary rate and MAFs for 100,000 SNPs randomly sampled from HapMap 3 CEU population data. (2nd order polynomial R²=0.6, P<10⁻⁸; Pearson r=−0.76; P<10⁻⁴) (Error bars: SEM)

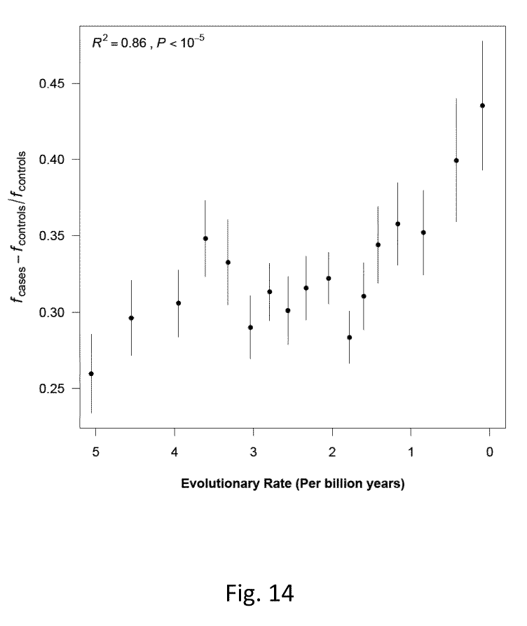

This is confirmed in an analysis of 3,372 dSNPs reported in 515 independent case-control genome-wide association studies (GWAS), which show a strong negative relationship between the evolutionary rate and the normalized difference in the dSNP frequencies between case and control populations (FIG. 14; R²=0.86, P<10⁻⁵).

FIG. 14 is a chart of the influence of evolutionary rate on the risk allele frequency disparities between cases and controls according to an embodiment of the present invention. Δf is the difference in risk allele frequency between cases (f_{cases}) and controls (f_{controls}) divided by f_{controls} to control for the MAF of the risk allele in healthy populations; Δf=(f_{cases}−f_{controls})/f_{controls}. (3rd order polynomial R²=0.86, P<10⁻⁵; Pearson r=0.74, P<10⁻³) (Error bars: SEM)

The above example encourages the use of evolutionary information as priors in improving dSNP discovery in disease association studies. They are particularly desirable because evolutionary information, such as the conservation scores, can be estimated from multispecies alignments for each position in the human genome independent of the population data, and could therefore be leveraged to establish a priori expectations for loci that alleles segregating in a disease association study represent reproducible disease associations. In an embodiment of the present invention, the utility of evolutionary conservation score (E) was explored as a means to reprioritize ad hoc the allelic P-value of association for a SNP to generate Erank=(P/MAF)×(1−E). As designed, E-rank ameliorates the evolutionary conservation effect and enables SNPs with even modest odds ratios that explain greater degree of heritability to become easily identifiable.

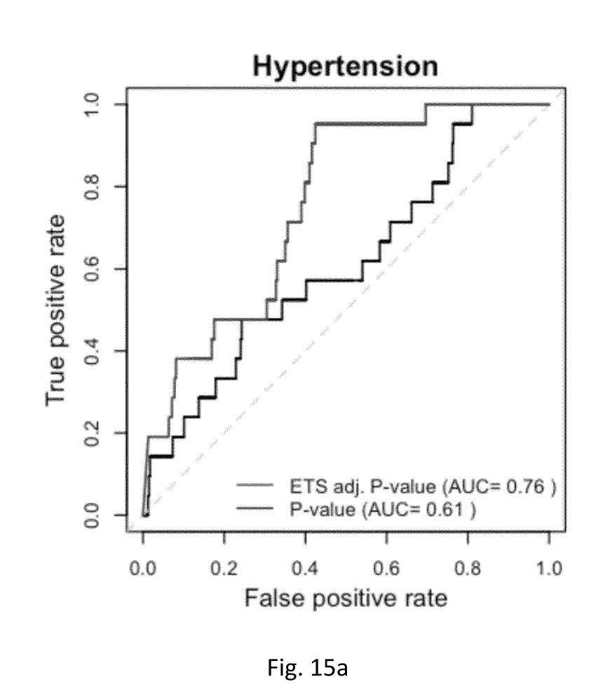

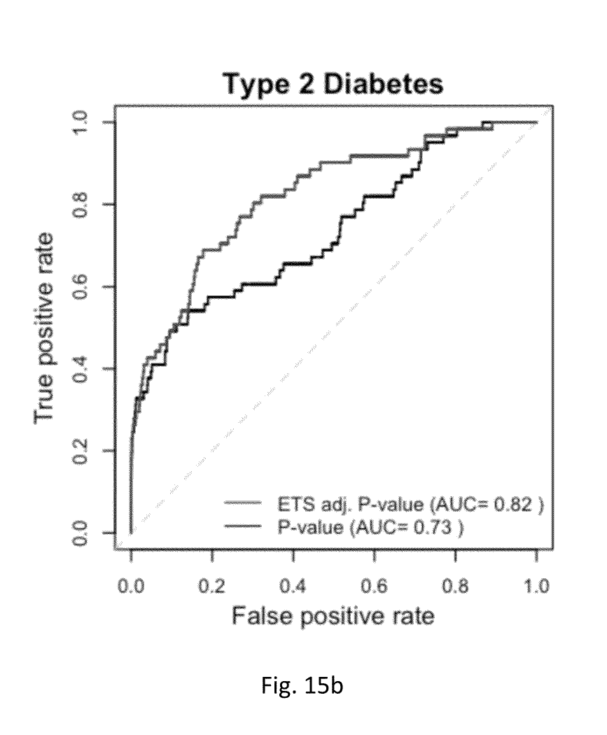

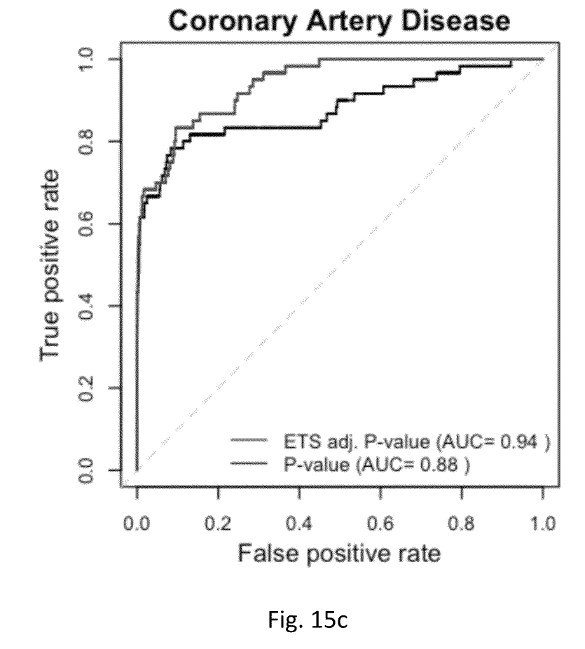

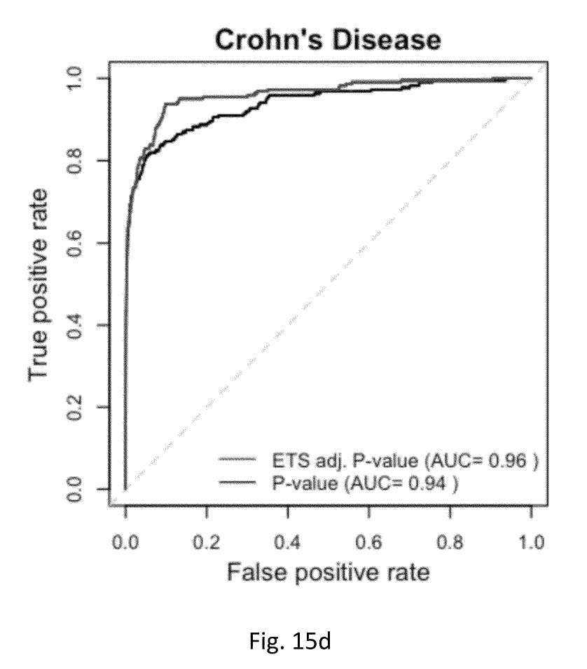

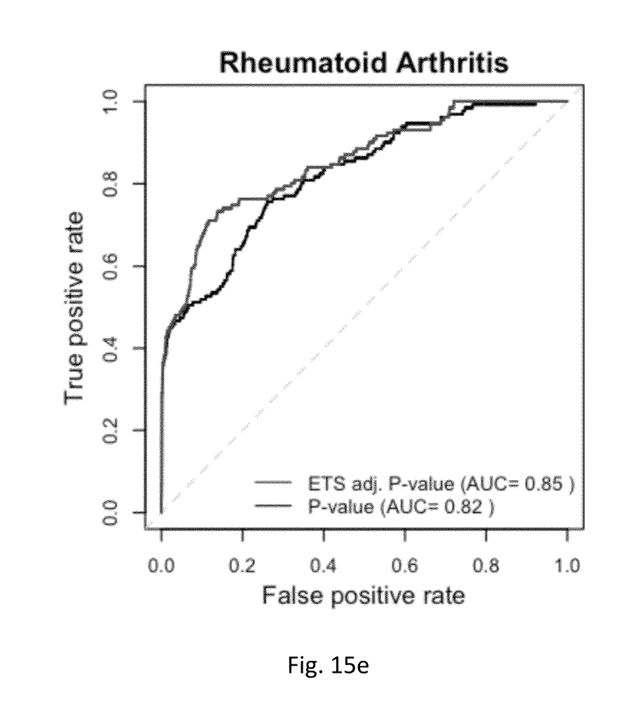

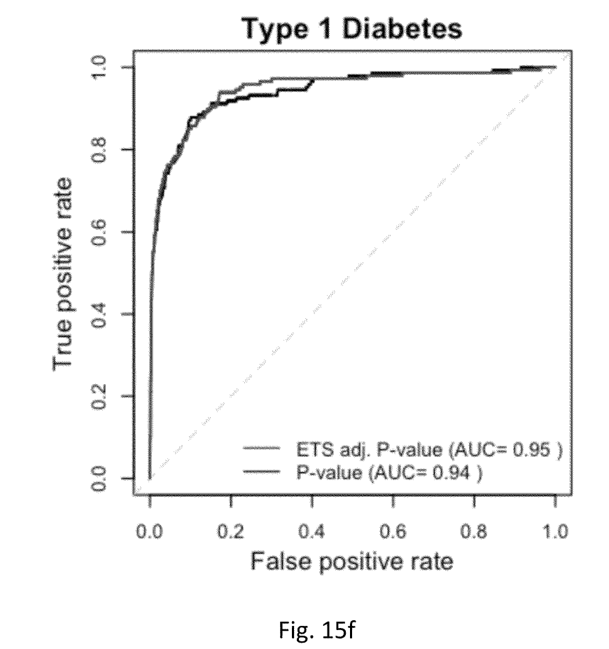

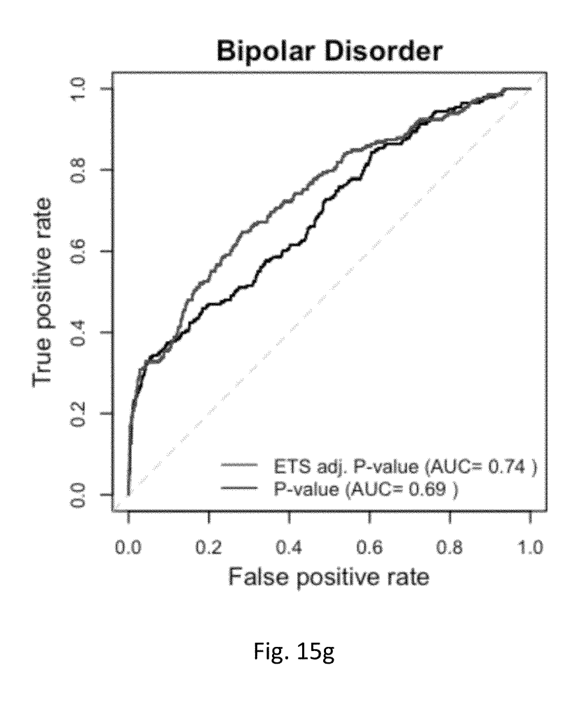

This modification was applied to the original association data for 500,000 loci profiled across seven common diseases by the Wellcome Trust Case Control Consortium. Performance was assessed by evaluating the predictive ability of E-rank vs. the P-value rank (P-rank) in discriminating dSNPs that have been replicated in three or more subsequent independent studies—used here as an indicator of likely true positive association. FIG. 15 shows the resulting Receiver Operating Characteristic (ROC) curves, where the area under the curve (AUC) represents the accuracy of P-rank and E-rank to predict replicated associations for the seven diseases. In every case E-rank performs better than P-rank in identifying loci with putatively true association.

FIG. 15a-g are a charts demonstrating that evolutionary adjustment improves discriminatory power to identify reproducible associations according to an embodiment of the present invention. Receiver Operating Characteristic (ROC) curves representing the accuracy to predict associations subsequently replicated in 3 or more independent association studies are shown for each of the seven disease association studies represented in the Wellcome Trust Case Control Consortium (WTCCC) data. The black line indicates the predictive accuracy of the original allelic association p-values estimated by comparison of cases vs. controls in the WTCCC study. The red line indicates the predictive accuracy after adjusting P-values according to the maximum evolutionary timespan (% ETS) of linked positions (E-rank). The grey diagonal line represents random performance (AUC=0.5).

To evaluate possible effects of SNP selection bias in an embodiment of the present invention, the same reprioritization and classifier evaluation was performed using the more stringent set of GWAS-only dSNPs. Because the number of gold standard SNPs in the stringent set is small compared to the full compliment of reported dSNPs, the ability was evaluated for the P-rank vs. E-rank methods to tag the genomic regions association with the stringent set of GWAS dSNPs. Specifically, the expected number of significant snps r for each disease was determined by totaling the number of associated SNPs falling under the Bonferroni correction threshold of P<5×10⁻⁷. Because the allelic architecture of diseases varies, the value of r can vary greatly among diseases. Associated SNPs were then ranked post-hoc by P-value (P-rank) and E-rank and then some kr) positions were stepped down in the ranking, where k is a positive integer, to determine the number of GWAS dSNP regions (see Methods) that were tagged by the first kr ranked SNPs comparing P-rank to E-rank.

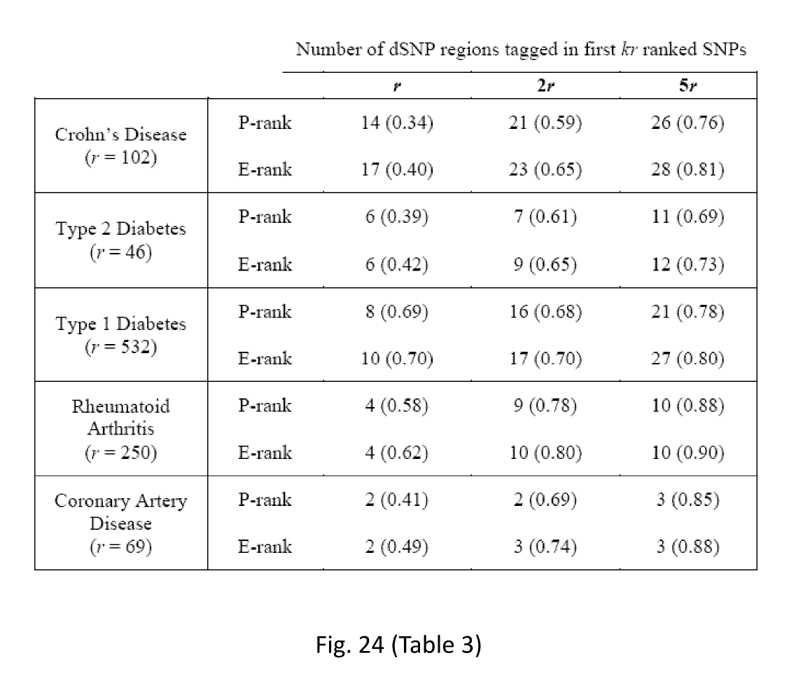

Classification was also performed at each kr threshold to estimate the accuracy as the ROC area under the curve of each method in tagging known regions. For all seven diseases represented in the WTCCC, it was found that the E-rank method outperforms the Prank approach in tagging regions harboring established GWAS dSNPs (FIG. 24 (Table 3)). Not only does the E-rank method tag more regions than P-rank in the same kr set of SNPs, but it does so with greater accuracy, meaning that the increase in sensitivity does not come at the cost of higher false-positive rate.

FIG. 24 (Table 3) is a table of the number of GWAS dSNP regions tagged by E-rank vs. P-rank according to an embodiment of the present invention. For each disease, the table shows a comparison between the P-rank and E-rank methods in tagging genomic regions linked to bona fide GWAS dSNPs for the respective disease. The number represents the count of regions tagged at the kr threshold where r is the expected number of significant SNPs estimated as the number of SNPs in the respective disease association results association at a significance level below the P<5×10⁻⁷ significance threshold. The number in parentheses is the associated ROC AUC value representing the accuracy in tagging the dSNP regions at the kr threshold. The results demonstrate that E-rank outperforms P-rank in nearly all cases. Results for Bipolar Disorder and Hypertension are not shown because there are not enough SNPs yet associated with these diseases to include in the stringent gold standard set of GWAS dSNPs.

### Discussion

Results from embodiments of the present invention suggest that contemporary GWAS studies are biased towards finding rare variants of low heritability by design. For example, a common allele at locus rs1111875 in a non-coding region flanking the HHEX gene locus exhibits inconsistent statistical association with the risk of Type 2 diabetes (T2D) across multiple independent studies, although this locus is estimated to have a population-attributable risk as high as 36% in the Dutch Breda cohort (van Vliet-Ostaptchouk, J. V. et al. HHEX gene polymorphisms are associated with type 2 diabetes in the Dutch Breda cohort. Eur J Hum Genet 16, 652-656 (2008)). The relatively high evolutionary rate of this locus (3.25 substitutions/Byr) indicates a low likelihood that alleles with high odds ratio would be found at the position, but the position is completely conserved across the mammalian lineage (100% positional conservation). Therefore, the evolutionary expectation is that any significantly segregating alleles found at this position are likely to be genuine associations. Indeed, this risk variant was ultimately established as a genuine association by combined analysis of multiple T2D association studies (95% CI for odds ratio=1.13-1.21).

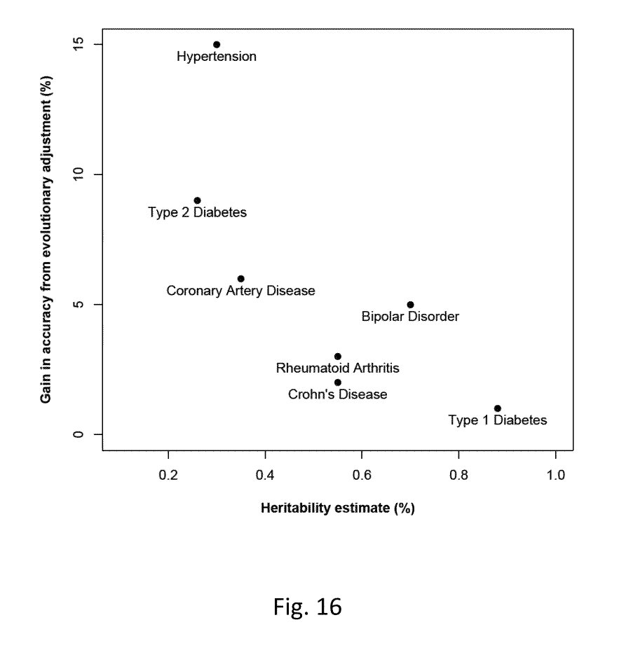

In this embodiment of the present invention, the greatest gains in accuracy were found for diseases that have been previously estimated to have relatively low degrees of heritability. Both hypertension and Type 2 diabetes (T2D) gain 15% and 9% accuracy, respectively, from the use of evolutionary priors and have total heritability estimates ≦30%. On the other end of the spectrum, the heritability of Type 1 diabetes (T1D) is estimated to be near 90%, and evolutionary priors do not provide significant additional gains above the high predictive accuracy (AUC=0.94) of the unadjusted association P-values. Across all seven diseases, it was observed that E-rank improvements track remarkably closely with the contemporary knowledge of the heritability of the diseases (FIG. 16), which suggests that evolutionary anatomies of associated risk variants could inform on the nature and complexity of the allelic architecture underlying common diseases.

FIG. 16 is a chart of the relationship between gain in accuracy from evolutionary adjustment and disease heritability according to an embodiment of the present invention. For each of the diseases measured in the WTCCC, the gain in predictive accuracy (e.g., difference between the E-rank AUC and the “raw” P-rank AUC) is plotted against the total heritability estimate for the disease.

For example, established risk variants for T2D only explain a minor fraction (<15%) of the heritability of T2D with up to thousands of undiscovered variants of modest effect expected to explain the remaining component. On the other hand, risk alleles in the MHC region alone explaining >50% of the genetic susceptibility to T1D. Alternative embodiments of the present invention may realize even greater gains in predictive power and enhance understanding of the relationship between evolutionary anatomies and genetic architectures of diseases.

Results from an embodiment of the present invention demonstrate the utility and clinical relevance of evolutionary properties derived from cross-species genome analysis, highlighting the need and importance of sequencing the genomes of species both closely and distantly related to humans in evolutionary time, to enable and improve the fidelity of evolutionary inferences bearing on human health and disease. Furthermore, the results presented here have implications for evaluating rare versus common-variant hypotheses concerning genetic susceptibility to common diseases, which is of great practical significance in clinical genomics.

In an embodiment of the present invention, it has also been shown that position-specific evolutionary information can increase the predictive power of individual association studies. Evolutionarily informed analyses of existing and future association data can enhance discovery of genetic disease susceptibility variants and offer further crucial insights into the genetic basis of human diseases.

Enhancement of Pharmacogenomics Assessment Using SNP Aggregation and Evolutionary Context of Positions

Genome-wide association studies (GWAS), which generally assay common variation and rely on relatively large effects, are now being widely applied to perform genome-wide scans for variants associated with pharmacological phenotypes. In the case of complex diseases, GWAS have yielded associated variants with modest overall effects. However, in the case of pharmacological phenotypes, initial results from pharmacogenomic GWAS appear to indicate a greater ability to discover variants with substantial effect size. Nevertheless, pharmacogenomic GWAS suffer many of the limitations of disease GWAS in that follow up studies are often required to elucidate the causative genes and variants latent in the GWAS results. Additionally, pharmacogenomic GWAS are also limited in power by small cohort sizes. Amongst the drugs whose pharmacological variance has been evaluated using the GWAS approach, warfarin (Coumadin) has emerged as a prominent pharmacogenomics case study with great translational potential.

Given its broad use, narrow therapeutic range, and severity of side effects, a comprehensive pharmacogenomic characterization of warfarin dose-response offers the potential for substantial clinical impact. Retrospective studies revealed the role of VKORC1, CYP2C9, and CYP4F2 in mediating abnormal variations in warfarin dose response, explaining approximately 30%, 10% and 5% of the variance in drug response respectively. The relationship between variants in these genes and atypical warfarin dose response has been subsequently confirmed by GWAS analysis. A method to estimate stable warfarin dose was developed by integrating information on patient VKORC1 and CYP2C9 genotypes with clinical factors. Although this method incorporated genotype information for only two warfarin pharmacogenes, the genotype-based method was able to explain ˜49% of the variance in stable dose, substantially outperforming the pure-clinical and fixed-dose approaches. The elucidation of additional large-effect pharmacogenes for warfarin and other genomic features might serve to dramatically increase the ability to predict warfarin dose response from genotype.

In an embodiment of the present invention, a method is presented for increasing the power of pharmacogenomic GWAS and detecting pharmacogenes predictive of drug response. This method according to an embodiment of the present invention characterizes the degree to which uncommon (e.g., low population frequency) alleles of a gene correlate with drug response. If uncommon alleles are associated with atypical drug response phenotypes, then the gene is considered a predictive pharmacogene and a putative marker for drug response. The straightforward basis for this approach is the assumption that individuals with uncommon alleles in pharmacogenes are more likely to respond abnormally to a drug.

Alleles can be maintained at low frequencies by evolutionary selection due to functional constraint, and are more likely to have an effect on phenotype, or result from random genetic drift, which is not expected to have a substantial functional effect. To compensate for this, a second method according to an embodiment of the present invention is implemented that incorporates evolutionary weights estimated for each genomic position, which can be estimated from cross-species genomic sequence alignments independent of human population characteristics.

Methods

### Warfarin GWAS Data

For validation in an embodiment of the present invention, a dataset of 181 patient genotypes (175 Caucasian, 6 Hispanic) and stable warfarin dosages was obtained from a warfarin GWAS study described by Cooper et al. (Cooper, G. M. et al. A genome-wide scan for common genetic variants with a large influence on warfarin maintenance dose. Blood 112, 1022-1027 (2008)). The list of SNPs measured by the Cooper et al. study was filtered so that the set of SNPs had a maximum pairwise r-squared linkage disequilibrium score of 0.2. The resulting set was then queried against the SCAN SNP and CNV Annotation Database to determine whether the SNPs were either contained within a given gene or within 5 kbp upstream or downstream of that gene. One exception to the SCAN SNP mapping was made so that rs10871454 mapped to VKORC1. This SNP is in linkage disequilibrium with rs9923231, a VKORC1 SNP.

### Using Knowledge to Limit the Hypothesis Testing Space

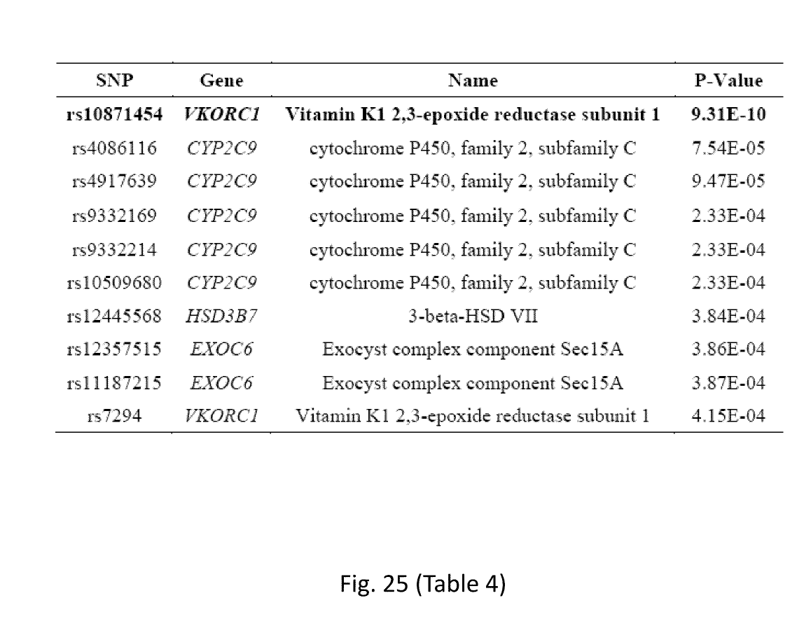

GWAS studies are hindered by multiple hypothesis testing corrections that significantly limit the power of analysis on smaller patient data sets. Pharmacogenomic knowledge bases integrate large amounts of data from the literature and biological experiments. Recently, an algorithm, called the PGxPipeline, was published that integrates pharmacogenomics and drug-binding databases to rank genes for their likelihood to be pharmacogenomic for a given drug (Hansen, N. T., Brunak, S. & Altman, R. B. Generating genome-scale candidate gene lists for pharmacogenomics. Clin Pharmacol Ther 86, 183-189 (2009)). The PGxPipeline was used to rank genes for their likelihood to be involved in the pharmacokinetics or pharmacodynamics of warfarin metabolism and action. This ranking of genes was then repeated for each of 486 other drugs for which pharmacogenetic interactions are known. These other drug gene rankings were then used to apply a significance score to the warfarin gene rankings Only the most significant (p-value≦0.05) warfarin genes were used the following analysis. 786 such genes were identified to have significant likelihood scores to be potential warfarin pharmacogenes. Of those, 228 contained SNPs that were measured by the Cooper GWAS study. This genes set is defined to be the Warfarin-Specific Pharmacogenome (WSP). The present analysis was limited to those 3,856 SNPs that were in these 228 genes. The univariate linear regression analysis used in the Cooper study was repeated for these 3,856 SNPs (FIG. 25 (Table 4)). FIG. 25 (Table 4) is a table of the top 10 of 3,856 SNPs fitting a univariate linear regression model of warfarin dose for 181 patients according to an embodiment of the present invention. Bold SNPs are significant after multiple hypothesis testing. Only rs10871454 (a SNP in 100% LD with VKORC1) was significant after correcting for multiple hypothesis testing.

### Derivation and Evaluation of a Candidate Gene-Score Based on Allele Frequencies

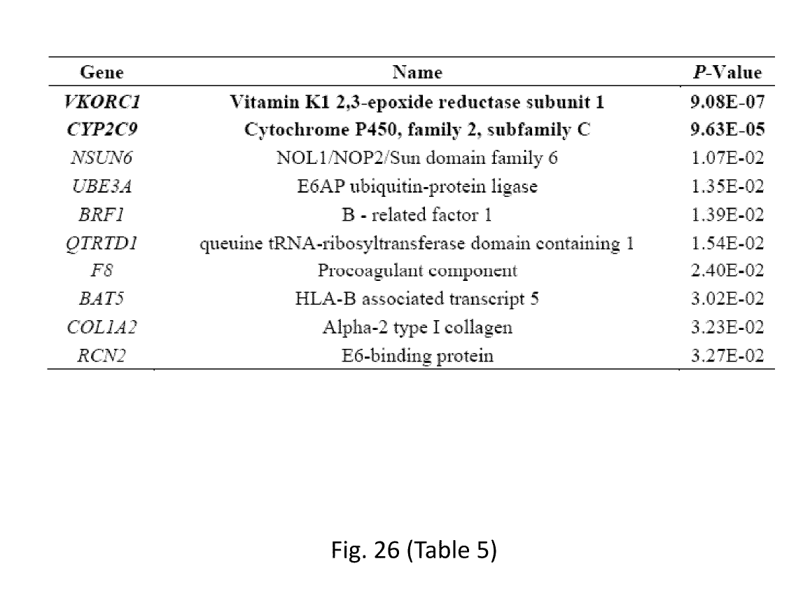

The 3,856 SNPs were aggregated by gene and a computed the gene-score for each gene based on the SNP allele frequencies. These features are based on the straightforward assumption that genes with a preponderance of low-frequency alleles in individuals with extreme drug response phenotypes are more likely to be modulating that response. Variants of pharmacogenes are important in determining drug response. As a proxy to the potential of variants in a pharmacogene to effect drug response, the pHap score is defined in an embodiment of the present invention. To calculate the pHap score for a given patient and a given gene, the negative log of each genotype frequency is first computed for each SNP in the given gene. The sum of these values is then taken and called the pHap score in an embodiment of the present invention. The pHap score for patient, i, and gene, j, is defined as:

$${pHap}_{i , j} = {\sum }_{k}^{{N}_{j}} - log ( {f}_{i , j , k} )$$

Where Nⱼ is the number of SNPs in gene j and f_{I,j,k} is the frequency of the allele of patient i for SNP k of gene j. There is a pHap score for each gene in the WSP for each patient. In total, 228 pHap scores were generated for each patient (for the 228 included genes). Each gene-score was then fitted in a univariate linear regression model to the dosage data and tested for the gene-score's ability to predict the dosage data (FIG. 26 (Table 5)). FIG. 26 (Table 5) is a table of genes with candidate gene-scores that significantly predict dose in a univariate linear regression model (p≦0.05) according to an embodiment of the present invention. Genes highlighted in bold are significant after correcting for multiple hypothesis testing.

### Modified Candidate Gene Score Incorporating Evolutionary Weights

Because of the expected and demonstrated relationship between cross-species evolutionary conservation and allele frequencies in modern human populations, it was desirable in an embodiment of the present invention to account for the fact that both low and high allele frequencies resulting from genetic drift could negatively impact the pHap score. A new score, evo-pHap, was derived in an embodiment of the present invention which incorporated an evolutionary weight term, w, which quantifies the degree of positional evolutionary conservation at the position harboring the SNP.

$$evo \text{-} {pHap}_{i , j} = {\sum }_{k}^{{N}_{i}} - {w}_{k} log ( {f}_{i , j , k} )$$

In this embodiment of the present invention, the evolutionary conservation was computed as the % Evolutionary Timespan (% ETS) that quantifies the temporal extent to which the position is occupied over the course of mammalian evolution. Similar to the approach taken in discussion above, an evolutionary conservation score was estimated using nucleotide sequence alignments obtained from the UCSC genome resource and the mammalian timetree phylogeny shown in FIG. 7.

### Redefinition to a Classification Problem

To test the methods of the present invention in their ability to identify genomic features that are predictive of phenotypes, the patients were divided into classes based on their stable dose. The first two classes consisted of patients who required a low stable dose of warfarin (≦3 mg/day) and the compliment set of patients. The latter two classes consisted of patients who required a high stable dose of warfarin (≧7 mg/day) and the compliment set of patients. Dividing the patients into these two sets of classes (low/not low and high/not high) redefines the task as a classification problem. This allows for training machine-learning algorithms on the features identified by this method and, if the features are discriminatory, predicting the drug response classification of the patient.

### Identification of Features to Distinguish Extreme Dose Patients

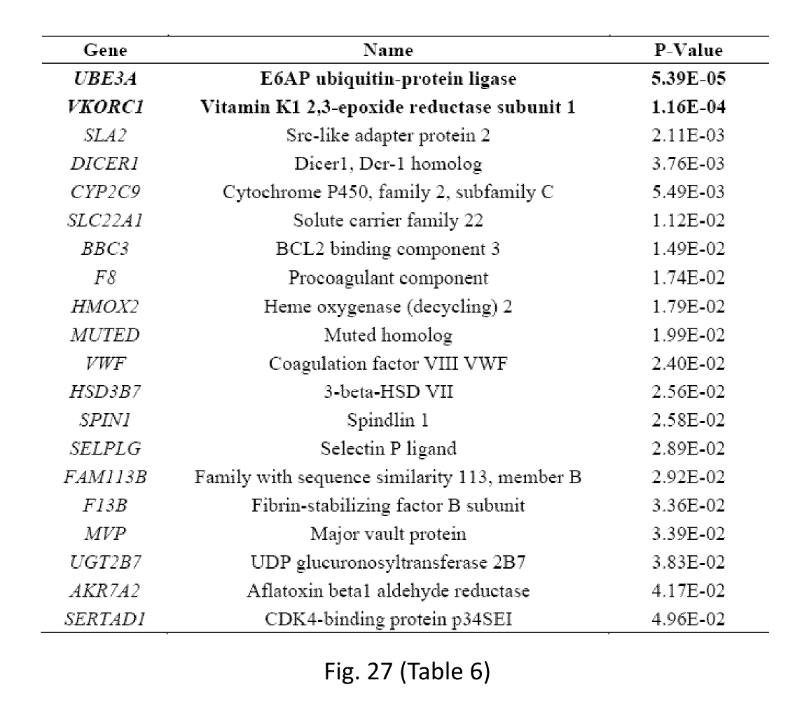

In an embodiment, patients were divided into two classes: those that required a low stable dose of warfarin and those who did not. For each patient, the gene-score of each gene was calculated and tested for the two classes of scores for the null hypothesis using a Student's t-test. Since 228 null hypotheses were being tested the p-values were corrected using the conservative Bonferroni multiple hypothesis correction method. The new threshold for significance was set at 0.001 (FIG. 27 (Table 6)). FIG. 27 (Table 6) is a table of the top 20 genes with candidate gene-scores that significantly distinguish between low dose patients and non-low-dose patients (p≦0.05) according to an embodiment of the present invention.

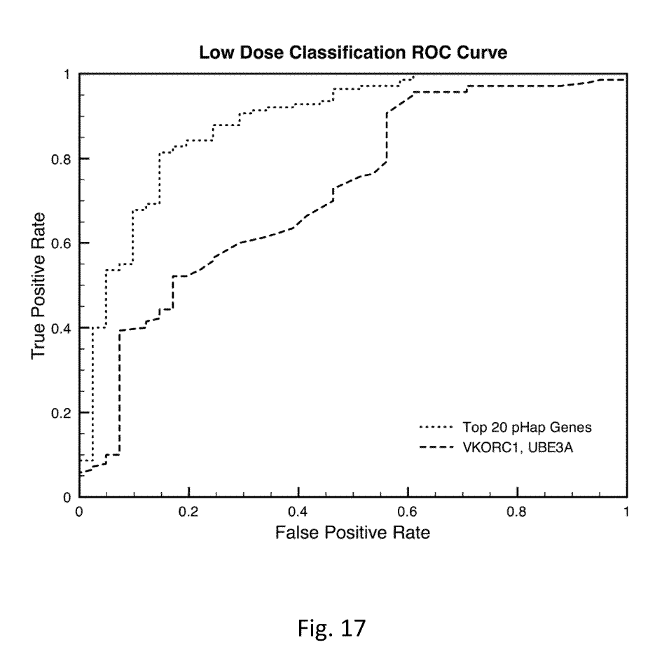

In an embodiment, two logistic regression classifiers were trained. The first classifier was on only the genes that were significant after correcting for multiple hypothesis testing and the second was trained on all genes that had a p-value≦0.05. The classifiers were evaluated using 10-fold cross validation. In 10-fold cross validation the classifier is trained on 9/10th of the data and the remaining 1/10th of the data is reserved to evaluate the performance of the classifier. This process is repeated 10 times and the average performance is plotted in a receiver operating characteristic (ROC) curve. The area under the ROC curve (AUROC) is a summary statistic for overall the performance of the classifier (FIG. 17).

FIG. 17 is a chart of the Receiver Operating Characteristic Curve for the low dose classification algorithms according to an embodiment of the present invention. Two classifiers were trained, the first, dotted line, on all 20 genes for which the genescores significantly distinguish low-dose and non-low-dose patients (AUROC=0.886, p≦0.05, FIG. 27 (Table 6)), and the second, dashed line, on only those genes that were significant after multiple hypothesis testing correction (AUROC=0.721, p≦0.001). Both classifiers have empirical p-value significance of less than 0.01 when tested using bootstrapping.

In order to evaluate the significance of the classification models an empirical p-value was derived. To derive an empirical p-value, the classifiers were trained on randomly chosen genes from the set of 228 in the WSP. The number of genes chosen at random corresponded to the number of genes used in the two classifiers. This process was repeated 100 times for each classifier.

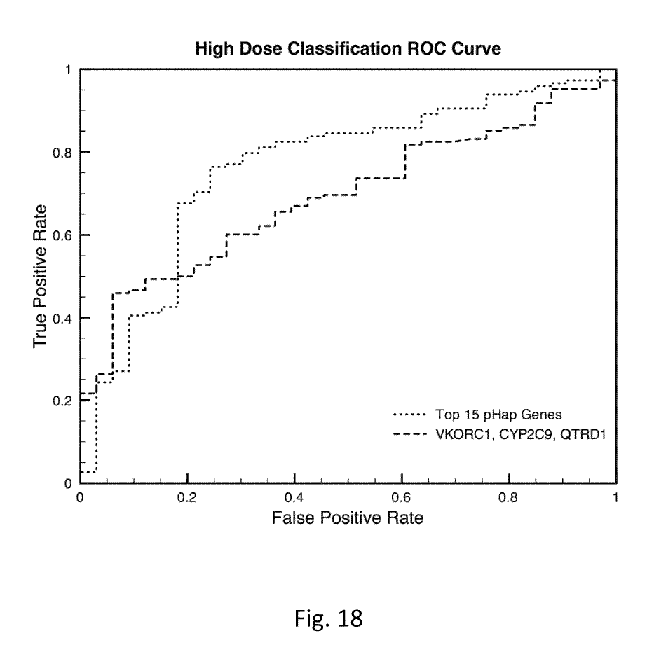

In an embodiment, the analogous analysis was repeated for the high-dose/not-high-dose patient classifications (FIG. 29 (Table 7), FIG. 18).

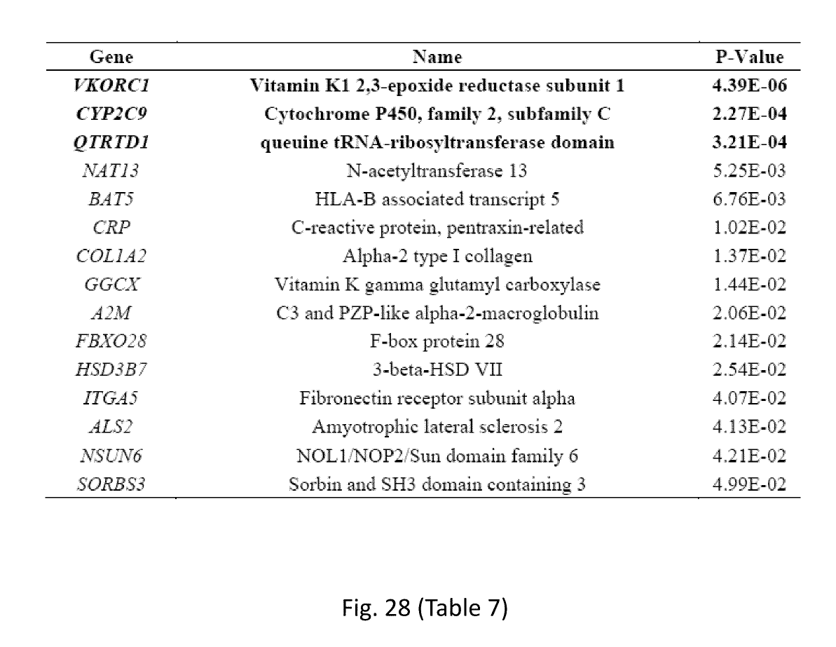

FIG. 28 (Table 7) is a table of the top 15 genes with candidate gene-scores that significantly distinguish between high dose patients and non-high-dose patients (p≦0.05) according to an embodiment of the present invention.

FIG. 18 is a chart of the Receiver Operating Characteristic Curve for the high dose classification algorithms according to an embodiment of the present invention. In an embodiment, two classifiers were trained, the first, dotted line, on all 15 genes for which the genescores significantly distinguish high-dose and non-high-dose patients (AUROC=0.76, p≦0.05, FIG. 28 (Table 7), and the second, dashed line, on only those genes that were significant after multiple hypothesis testing correction (AUROC=0.69, p≦0.001, FIG. 24 (Table 3). Both classifiers have empirical p-value significance of less than 0.01 when tested using bootstrapping.

Results

### Using Knowledge to Limit the Hypothesis Testing Space

In an embodiment of the present invention, 228 genes were identified that were likely to be pharmacogenes for warfarin and which also contained SNPs measured in the Cooper warfarin response GWAS data set (See Methods). There were 3,856 SNPs contained within these 228 genes. Each of the 3,856 SNPs were tested with a univariate linear regression model for its ability to predict warfarin dosage, the exact analysis performed by Cooper, et al. but with the advantage of testing fewer hypotheses. The results of this analysis closely resemble the results of the Cooper analysis except that a much less strict significance threshold is necessary to correct for multiple hypothesis testing (1.3e-5 as opposed to 1.0e-7). Even with this lower threshold, only one SNP, rs10871454 (VKORCI), was significant after correction (FIG. 25 (Table 4)).

### Derivation and Evaluation of a Candidate Gene-Score Based on Allele Frequencies

In an embodiment, each SNP was assigned to a gene if the SNP was within 5 kbp of the boundary of the gene. Some SNPs mapped to more than one gene. The SNPs were then aggregated into genes using this mapping and calculate each gene's pHap gene-scores. Each gene-score was then tested with a univariate linear regression model for its ability to predict warfarin dosage, again, the same analysis performed by Cooper, except that in the embodiment currently being described only 228 hypotheses were tested and each gene-score is a summary of a set of SNPs frequencies. In this analysis both VKORC1 and CYP2C9 are significant for predicting stable warfarin dosage (FIG. 26 (Table 5)). VKORC1 and CYP2C9 pass the corrected significance threshold of 1e-3 with p-values of 9.1e-7 and 9.6e-5 respectively.

### Extreme Dose Response Warfarin Response Models

The gene-score was calculated for each of the 228 genes in the WSP for each patient in two classes: low dose patients and the compliment. The distributions of gene-scores of the two classes were tested for the null hypothesis, namely that the means of the distributions were equal. Two genes significantly distinguish the two classes after corrected for multiple hypothesis testing, VKORC1 and UBE3A with p-values of 1.2e-4 and 5.4e-5 respectively. 18 other genes had p-values that were less than 0.05, but not significant after multiple hypothesis testing (FIG. 27 (Table 6)).

FIG. 27 (Table 6) is a table of the top 20 genes with candidate gene-scores that significantly distinguish between low dose patients and non-low-dose patients (p≦0.05) according to an embodiment of the present invention. P-Values are result of t-test between low-dose and non-low-dose distributions of genescores. Genes highlighted in bold are significant after correcting for multiple hypothesis testing.

In an embodiment, a logistic regression classification model was trained on VKORC1 and UBE3A genescores and evaluated with 10-fold cross validation (FIG. 17). The AUROC was 0.721 (significance p-value <0.01). A second logistic regression classification model was trained on the 20 genes that had a p-value≦0.05 (FIG. 17). The AUROC of this classifier was 0.886 (significance p-value <0.01).

Analogously for the high-dose model, three genes were found to have significant pvalues after multiple hypothesis testing, VKORC1, CYP2C9, and QTRTD1: p-values of 4.4e-6, 2.3e-4, and 3.2e-4 respectively. 12 other genes had p-values≦0.05 before multiple hypothesis correction (FIG. 28 (Table 7)).

FIG. 28 (Table 7) is a table of the top 15 genes with candidate gene-scores that significantly distinguish between high dose patients and non-high-dose patients (p≦0.05) according to an embodiment of the present invention. P-Values are result of t-test between low-dose and non-low-dose distributions of genescores. Genes highlighted in bold are significant after correcting for multiple hypothesis testing.

In an embodiment, a logistic regression classification model was trained on VKORC1, CYP2C9, and QTRTD1 and evaluated with 10-fold cross validation (FIG. 18). The AUROC was 0.693 (significance p-value <0.01). A second logistic regression classification model was trained on the 15 genes that had a p-value 0.05 (FIG. 18). The AUROC of this classifier was 0.764 (significance p-value <0.01).

### Evolutionary Weighting of SNP Pharmacogene SNPs

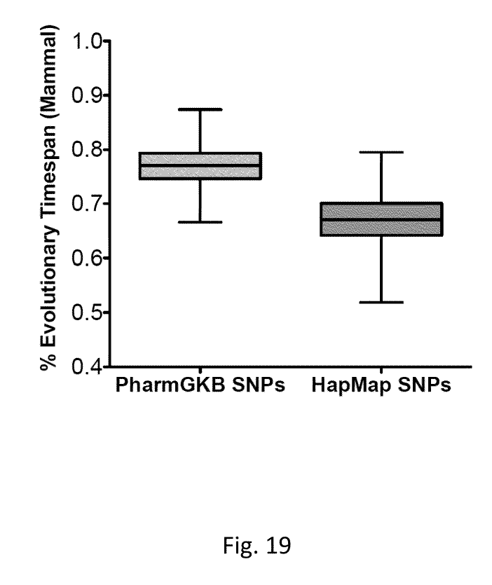

In an embodiment of the present invention, to first explore the feasibility of using evolutionary features for pharmacogenomics variants, a high-quality set of established pharmacogenomics variants was downloaded from the PharmGKB resource, which was evaluated for distinct evolutionary features. Pharmacogenomic variants from this set were found at positions with significantly higher positional conservation (% ETS) compared to normal population variation captured in HapMap (FIG. 19) (t-test P<5E-12).

FIG. 19 is a chart of the distributions of positional evolutionary conservation for pharmacogenomics and population SNPs according to an embodiment of the present invention. The positional conservation quantified as the % ETS is compared between 900 unique SNPs from PharmGKB and 100,000 randomly sampled SNPs from HapMap.

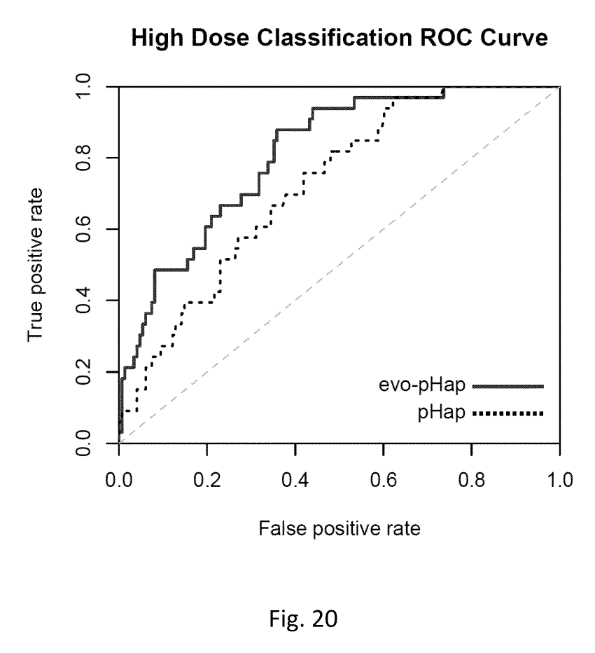

This finding establishes a baseline motivation for the incorporation of evolutionary features into the pHap method to derive the evo-pHap method (see Methods). Performing the Low and High warfarin dose classifications using the evo-pHap method, a significant increase over the pHap method was observed which only incorporates information from modern population allele frequencies. Applying the evo-pHap method for High dose classification, it is found more accurate (AUROC=0.86) than the baseline pHap method, which was already an improvement from the model that incorporated only the known associated warfarin pharmacogenes (AUROC=0.76) (FIG. 20).

FIG. 20 is a chart of the Receiver Operating Characteristic Curve for the high dose classification comparing the pHap and evo-pHap methods according to an embodiment of the present invention. Inclusion of cross-species evolutionary weights in the evo-pHap score realizes appreciable improvements in accuracy (AUROC=0.86) classifying patients requiring high stable dose of warfarin compared to the pHap method (AUROC=0.76), which incorporates only the observed population allele frequencies.

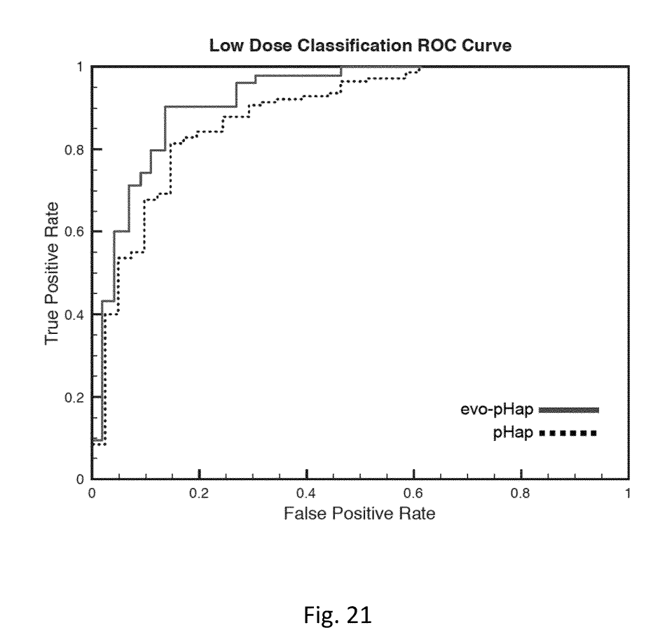

FIG. 21 is a chart of the Receiver Operating Characteristic Curve for the low dose classification comparing the pHap and evo-pHap methods according to an embodiment of the present invention. Inclusion of cross-species evolutionary weights in the evo-pHap score realizes appreciable improvements in accuracy (AUROC=0.86) classifying patients requiring high stable dose of warfarin compared to the pHap method (AUROC=0.76), which incorporates only the observed population allele frequencies.

In an embodiment applying the evo-pHap method for Low dose classification, it is found more accurate (AUROC=0.92) than the baseline pHap method, which was already an improvement from the model that incorporated only the known associated warfarin pharmacogenes (AUROC=0.88).

### Discussion

In an embodiment of the present invention, a novel method for integrating pre-existing pharmacological knowledge and scoring candidate genes from association studies is disclosed. Among other things, the filtering and scoring method is capable of identifying candidate genes explaining a large proportion of warfarin dose response phenotypes.

The pHap value according to an embodiment of the present invention is a simple measure of how “extreme” an individual's variants are in a particular gene: if all the SNPs show minor alleles, then the individual has a very high pHap value for that gene. If all the SNPs show major alleles, then the individual has a low value for that gene. An embodiment of the present invention has shown that this aggregate measure of genotype has the advantage of aggregating genetic variation in order to reduce the number of hypotheses tested. This measure cannot only increase the power to identify candidate genes that explain dosage variation but also can identify candidate genes for extreme phenotypes.

An embodiment of the present invention was validated on the warfarin GWAS study by Cooper et al., which attempted to identify candidate genes by examining a SNPs ability to predict dosage in a univariate linear regression model. The low number of patients in the cohort, however, limited the power of the Cooper analysis, which is a common problem in drug GWAS. When the methods of embodiments of the present invention were applied to the same data set, it was possible to identify the two best characterized genes responsible for variation in warfarin dose response, VKORC1 and CYP2C9. It is interesting to note that the knowledge filtration method alone will not identify both of these two genes (FIG. 25 (Table 4)). The pHap, which summarizes the aggregate contribution of a set of SNPs, is also needed in order to identify CYP2C9 significantly (FIG. 26 (Table 5)).

It was shown that an embodiment of the present invention can significantly identify features for a machine learning classification algorithm. High performance is achieved in an embodiment of the present invention when classifying between low/not low-dose patients and between high/not-high dose patients (AUROCs of 0.88, FIG. 17; and 0.76, FIG. 18, respectively). Using an empirical bootstrapping approach, it was demonstrated in an embodiment that the identified genes are significant. In both cases the AUROC of the model was the highest observed, corresponding to a p-value <0.01.

Further, it was demonstrated in an embodiment of the present invention that incorporation of evolutionary prior weights estimated for genomic positions from cross-species alignments yields even greater classification performance using a SNP aggregation approach. In the case of the High dose classification the patient classification accuracy is increased 10%. However, in an embodiment, only a single evolutionary feature (% ETS) was evaluated, while many additional features can be estimated for each genomic position. In other embodiments of the present invention, the effects of additional evolutionary features can be incorporated into the evo-pHap score, which can yield improvements in accuracy.

An embodiment of the present invention is dependent upon being able to identify potentially important pharmacogenes. It is important to note that the algorithm of this embodiment that was used to rank genes for their potential to be pharmacogenomic does not require the drug to be previously known and will predict pharmacogenes for novel chemical structures.

The results of this embodiment offer support for the applicability of allele-based pharmacogenetic models for the prediction of drug response phenotype. In addition, it opens up avenues for candidate pharmacogene discovery. In other embodiments of the present invention, methods can be improved through the investigation of more sophisticated classification methods and identification of additional genetic and genomic features predictive of drug response. In yet other embodiments, the application of the methods of the present invention can be expanded to additional drugs, with the overarching aim of developing an embodiment that is predictive and robust across a broad range of drugs.

An embodiment of the present invention has been disclosed that incorporates pharmacogenomic knowledge integration and a gene scoring system based on SNP aggregation to enhance pharmacogene discovery from pharmacogenomics GWAS. This approach was applied in an embodiment to a published warfarin GWAS data set comprising 181 individuals and to find that an embodiment of the methods of the present invention can increase the power of the GWAS to identify established warfarin pharmacogenes VKORC1 and CYP2C9, and implicate several novel warfarin pharmacogenes. Additionally, embodiments of the methods of the present invention can be used to discriminate between low-dose (AUROC=0.88) and high-dose (AUROC=0.76) responders, establishing a basis of direct clinical utility for the approach. An embodiment was described using evolutionary weighting to realize accuracies in discriminating between low-dose (AUROC=0.92) and high-dose (AUROC=0.86) responders.

Based on the performance observed with the warfarin GWAS, other embodiments of the present invention can be applied to additional pharmacogenomic GWAS as well as GWAS characterising other traits of clinical interest. Other embodiments can be used to explore the utility of additional evolutionary features in pharmacogenomics assessment of warfarin, and to expand the assessment to additional drugs to evaluate the general utility of both the SNP aggregation approach and the evolutionary weighting scheme.

### CONCLUSION

An important issue in the present disclosure is that all forms of human genetic variation contributing to the etiology and pathophysiology of modern human diseases have distinct and quantifiable evolutionary histories, which can be computed for every position in the human genome independent of human population characteristics, and used as informative quantitative priors in the discovery and assessment of variants of clinical importance in modern human populations. Three issues were addressed to evaluate both the theoretical basis and applied utility of embodiments of the present invention.

### The Null Evolutionary Hypothesis for Genomic Medicine

To address this issue, emerging genomic data characterizing individuals and populations from the perspective of established molecular evolutionary theory was evaluated. Through simulation and evaluation of the empirical data, evidence is found that the classical Neutral Theory of molecular evolution best explains patterns of both neutral and clinical genomic variation observed in modern individuals and populations. The Neutral Theory has been shown to explain the origins and distribution of Mendelian and complex disease mutations. It is also found that the distributions of both rare and common variation within personal genomes and also across human populations conform to the expectations long-established by Neutral Theory. In addition, many statistical and computational methods incorporating the theoretical framework of Neutral Theory are available. A neutral evolutionary perspective provides medical practitioners with a ready, clinically informative and actionable evolutionary framework that enables objective assessment of genomic variation bearing on clinical phenotypes.

While these conclusions are strongly supported by simulation and evaluation of empirical genomic data, only a handful of high-coverage personal genomes have been released into the public at the time of this disclosure. The future availability of high-quality, complete genomic sequences of large populations will enable more rigorous evaluation of this question, specifically with regards to the distribution of novel and low-frequency variants, which are predicted by Neutral Theory and other evolutionary frameworks to conform to specific evolutionary expectations, which will then be testable when such data becomes available.

### Cross-Species Positional Evolutionary Priors to Inform and Improve Discovery of Disease-Associated Variants

To address this issue, an evolutionary meta-analysis of Genome-wide disease association studies was undertaken, which contrasts genetic variation between disease cohorts and healthy populations to discover single nucleotide polymorphisms (SNPs) underlying genetic architectures of human diseases. Specifically, a multispecies comparative genomic meta-analysis was performed of 6,720 risk variants for more than 420 disease phenotypes reported in 1,814 studies, which aimed investigate the role of evolutionary histories of genomic positions on the discovery and reproducibility of disease associated SNPs (dSNPs) identified by association studies. dSNPs are disproportionately discovered at conserved genomic loci in both coding and non-coding regions, as the effect size (odds ratio) of dSNPs relates strongly to the evolutionary conservation of their genomic positions. Because of historical evolutionary constraint and its effect on allele frequencies in modern populations, an embodiment of the present invention demonstrated that association studies are predisposed to discover rare variants with of large effect and common variants of small effect, both of which individually explain small proportions of the genetic variance of disease traits in a population. Using published data from a large case-control study, it was demonstrated in an embodiment that the use of quantitative multispecies evolutionary features can be used to modify association statistics from individual association studies post-hoc to improve the power of association statistics to prioritize SNPs with reproducible genetic disease associations. This work demonstrates that long-term evolutionary histories of genomic positions are have utility in reassessing data from existing disease association studies and could potentially inform the design and analysis of future studies aimed at revealing the genetic basis of common human diseases. An embodiment of the present invention included a method called E-rank, which can be directly applied to present and future GWAS results to prioritize variants for follow-up studies. These results demonstrate the utility of evolutionary information in the discovery of disease-associated variation.

### Cross-Species Positional Evolutionary Priors to Inform and Improve Discovery and Clinical Assessment of Pharmacogenomic Variation

To address this issue, a two-part approach was developed in an embodiment of the present invention. First, because pharmacogenomics association studies are traditionally characterized by small sample sizes, and are therefore typically limited in power, a novel knowledge integration and SNP aggregation approach is implemented for identifying gene-associated genetic variants impacting drug response thereby reducing the hypothesis space. The SNP aggregation method according to an embodiment of the present invention characterizes the degree to which uncommon alleles of a gene are associated with drug response. This method is applied to a published warfarin GWAS data set comprising 181 individuals. Embodiments of the present invention can increase the power of the GWAS to identify both VKORC1 and CYP2C9 as warfarin pharmacogenes, which are now established as bona-fide warfarin pharmacogenes, where the original GWAS analysis had only identified VKORC1. Additionally, the method according to an embodiment of the present invention can be used to discriminate between low-dose (AUROC=0.88) and high-dose (AUROC=0.76) responders with appreciable accuracy.

Because human population allele frequencies used as terms in the SNP aggregation method according to an embodiment of the present invention are a function of the evolutionary context of a genomic position, position-specific evolutionary priors were incorporated that were computed across species into the scoring method as an approach to weight observed allele frequencies relative to their expected functional importance. For example, a low-frequency allele at a non-conserved position would be down-weighted, as the observed frequency is likely a result of genetic drift. Alternatively, a low-frequency variant at a conserved position would be upweighted as it is likely being maintained at low frequencies by negative selection. It was shown in an embodiment of the present invention that addition of evolutionary weights to the SNP aggregation method improves both the prediction of High and Low dose warfarin classes from individual patient genotypes.

Overall, these results support the use of this approach as a new route for pharmacogenomics variant discovery and assessment, and offer support for the use of cross-species evolutionary features of genomic positions in the clinical assessment of pharmacogenomic variation. It is acknowledged that drugs interact with many metabolizing enzymes and cellular receptors that have likely undergone periods of both negative and positive adaptive selection across species evolution, and possibly within recent human evolution. Other embodiments can incorporate evolutionary information from both long-term species evolution and recent adaptive evolution in humans and closely related primates could improve both the discovery and clinical assessment of pharmacogenomics variation.

Among other things, the present disclosure is directed to the study of clinically associated variation in DNA sequence. There is growing functional genomic data in the public domain characterizing genome-wide gene expression and transcription factor binding within individuals, across populations, and across species, and such data is expected to rapidly expand in volume in the near future as relevant high-throughput molecular profiling technologies continue gains in quality and efficiency. The theoretical and methodological basis of the present disclosure provides for the development of further embodiments as would be know to those ordinary skill in the art.

It should be appreciated by those skilled in the art that the specific embodiments disclosed above may be readily utilized as a basis for modifying or designing other image processing algorithms or systems. It should also be appreciated by those skilled in the art that such modifications do not depart from the scope of the invention as set forth in the appended claims.

What is claimed is:

1. A computer-implemented method for assessing clinical relevance of genetic information, comprising:
estimating an evolutionary rate of change for a plurality of nucleotides in a genome;
determining a positional conservative metric for the plurality of nucleotides in the genome;
determining an evolutionary permissible allele profile for the plurality of nucleotides in the genome;
generating a measure of clinical relevance based on the estimated evolutionary rate of change, positional conservative metric, and evolutionary permissible allele profile.

2. The method of claim 1, wherein the measure of clinical relevance includes an expectation that an allele at a first position has clinical relevance.

3. The method of claim 1, wherein at least one of the estimated evolutionary rate of change, positional conservative metric, and evolutionary permissible allele profile are determined using data for human genomic regions.

4. The method of claim 3, wherein the data for human genomic regions is extracted from a genomic database.

5. The method of claim 3, wherein the data includes transcription factor binding data.

6. The method of claim 3, wherein the data includes differential gene expression data.

7. The method of claim 3, wherein the data includes common disease variant associations.

8. The method of claim 1, further comprising determining at least one effect related to the measure of clinical relevance.

9. The method of claim 1, further comprising constructing a first model predictive of allelic functional effects.

10. The method of claim 9, wherein the model is constructed using machine learning algorithms.

11. A computer-readable medium including instructions that, when executed by a processing unit, cause the processing unit to assess clinical relevance of genetic information, by performing the steps of:
estimating an evolutionary rate of change for a plurality of nucleotides in a genome;
determining a positional conservative metric for the plurality of nucleotides in the genome;
determining an evolutionary permissible allele profile for the plurality of nucleotides in the genome;
generating a measure of clinical relevance based on the estimated evolutionary rate of change, positional conservative metric, and evolutionary permissible allele profile.

12. The computer-readable medium of claim 11, wherein the measure of clinical relevance includes an expectation that an allele at a first position has clinical relevance.

13. The computer-readable medium of claim 11, wherein at least one of the estimated evolutionary rate of change, positional conservative metric, and evolutionary permissible allele profile are determined using data for human genomic regions.

14. The computer-readable medium of claim 13, wherein the data for human genomic regions is extracted from a genomic database.

15. The computer-readable medium of claim 13, wherein the data includes transcription factor binding data.

16. The computer-readable medium of claim 13, wherein the data includes differential gene expression data.

17. The computer-readable medium of claim 13, wherein the data includes common disease variant associations.

18. The computer-readable medium of claim 11, further comprising determining at least one effect related to the measure of clinical relevance.

19. The computer-readable medium of claim 11, further comprising constructing a first model predictive of allelic functional effects.

20. The computer-readable medium of claim 19, wherein the model is constructed using machine learning algorithms.

21. A computing device comprising:
a data bus;
a memory unit coupled to the data bus;
a processing unit coupled to the data bus and configured to
estimate an evolutionary rate of change for a plurality of nucleotides in a genome;
determine a positional conservative metric for the plurality of nucleotides in the genome;
determine an evolutionary permissible allele profile for the plurality of nucleotides in the genome;
generate a measure of clinical relevance based on the estimated evolutionary rate of change, positional conservative metric, and evolutionary permissible allele profile.
